(19) United States
(12) Patent Application Publication
(10) Pub. No.: US 2021/0358496 A1
(43) Pub. Date: Nov. 18, 2021

(54) A VOICE ASSISTANT SYSTEM FOR A VEHICLE COCKPIT SYSTEM

(71) Applicant: VISTEON GLOBAL TECHNOLOGIES, INC., Van Buren Township, MI (US)

(72) Inventor: Ranjeeth Kumar Sukumar, Canton, MI (US)

(73) Assignee: VISTEON GLOBAL TECHNOLOGIES, INC., Van Buren Township, MI (US)

(21) Appl. No.: 17/281,127

(22) PCT Filed: Oct. 3, 2019
(86) PCT No.: PCT/US2019/054470

§ 371 Date: Mar. 29, 2021

Related U.S. Application Data
(60) Provisional application No. 62/740,681, filed on Oct. 3, 2018.
(60) Provisional application No. 62/776,951, filed on Dec. 7, 2018.

(51) Int. Cl. G10L 15/22; G10L 15/26; G06F 40/20; G10L 13/047; G10L 15/08; G10L 21/02; G06N 20/00

(52) U.S. Cl. CPC G10L 15/22; G10L 15/26; G06F 40/20; G10L 13/047; G10L 2015/223; G10L 21/02; G06N 20/00; G10L 2015/088; G10L 15/08

(57) ABSTRACT

A method of operating a voice assistant system (30) of a vehicle (20) includes inputting (104) a voice input (200) into a computing device (28), and converting (106) the voice input into a natural language input text data file (224) with a speech-to-text converter (50). The natural language input text data file is analyzed (108) to determine a requested action (108). An action identifier (44) determines if the requested action is a cloud-based action (112) or an on-board based action (122). When the requested action is determined to be the cloud-based action, the computing device communicates (114) the text data file to a cloud-based service provider (226). When the requested action is determined to be the on-board based action, then the computing device executes (126) the requested action with a skill (46) operable on the computing device to perform the requested action.

### CROSS-REFERENCE TO RELATED APPLICATIONS

This application claims the benefit of U.S. Provisional Applications No. 62/740,681, filed Oct. 3, 2018, and 62/776,951, filed Dec. 7, 2018, each of which are hereby incorporated by reference in their entirety.

### TECHNICAL FIELD

Embodiments described herein generally relate to a vehicle cockpit system, and in particular, to a voice assistant system for the vehicle cockpit system. In some embodiments, the voice assistant system may be part of a vehicle infotainment system.

### BACKGROUND

Vehicle cockpit systems for vehicles may include a voice assistant system. A conventional voice assistant system uses a series of rigid, fixed rules that enable a user to vocally input a verbal request, such as a question or command. If the conventional voice assistant system understands the verbal request based on the rigid, fixed rules of the conventional system, the voice assistant system executes the request if it is otherwise able to do so. The series of rigid, fixed rules that conventional voice assistant systems use to understand the verbal request include specific, predefined triggers, phrases, or terminology, which the user learns in order to effectively use the conventional voice assistant systems. Additionally, the user should speak in a manner that is understandable by the conventional voice assistant system, e.g., use a predefined syntax, dialect, accent, speech pattern, etc. If the user fails to use the specific, predefined triggers, phrases, or terminology that the conventional voice assistant systems are trained to understand, or if the user speaks in a manner that the conventional voice assistant system is unable to interpret, then the conventional voice assistant systems are unable to understand the verbal request, and fail to provide the requested action. For example, if the fixed and rigid rules of the conventional voice assistant system is trained to recognize a specific verbal input of “increase cabin temperature” in order to turn on a cabin heater of the vehicle, and the user inputs the verbal request of “turn on the heat”, the conventional voice assistant systems will not understand the verbal input, and will fail to turn on the cabin heater and warm the vehicle cabin.

Additionally, conventional voice assistant systems are unable to learn or otherwise adapt to the user. As such, the user adapts to the conventional voice assistant systems. If the user fails to adapt to the fixed, rigid rules of the conventional voice assistant system, such as by learning the specific predefined triggers, phrases, or terminology, or by speaking in a manner, syntax, dialect, accent, etc. that is understandable by the conventional voice assistant system, the usability of the conventional voice assistant system is reduced.

Furthermore, many conventional voice assistant systems implement complex computing systems and software architectures, which often utilize intensive processing power, and are based on proprietary software. The proprietary software and fixed, rigid rules of these conventional voice assistant systems often restricts users from improving performance of the voice assistant systems.

Some voice assistant systems operate on the Cloud, in which case the voice input is transmitted through the Cloud to an internet service provider, which then executes the request from the voice input. The term “Cloud” will be understood by those skilled in the art as to its meaning and usage, and may also be referred to herein as an “off-board” system. However, voice assistant systems that operate on the Cloud are dependent upon the vehicle having a good internet connection. When the vehicle lacks internet service, a voice assistant system that operates on the Cloud is inoperable. Additionally, some vehicle functions may only be executed by systems located on-board the vehicle. Cloud-based voice assistant systems that operate on the Cloud may not be able to execute on-board vehicle function, or inject additional steps and/or processes into the operation and control of the various on-board only vehicle functions. Other voice assistant systems operate completely on-board the vehicle, in which case the programming, memory, data, etc., implemented to operate the voice assistant system is located on the vehicle. These on-board voice assistant systems are unable to access information through the internet, and therefore provide limited results and functionality for external information. In today's world of “connected everything,” however, there are various reasons a vehicle occupant will desire external information in the vehicle while maintaining the level of usability and safety that arise from use of the voice assistant system for on-board functions.

### SUMMARY

A system for a vehicle is provided herein. The system comprises: a microphone operable to generate an electronic input signal in response to an acoustic input signal; a speaker operable to generate an acoustic output signal in response to an electronic output signal; a transceiver operable to communicate with a cloud-based service provider; and a computing device in communication with the microphone, the speaker and the transceiver.

The computing device includes: a voice model operable to recognize a voice input within the electronic input signal; a speech-to-text converter operable to convert the voice input into a natural language input text data file; a text analyzer operable to determine a requested action within the natural language input text data file; an action identifier operable to determine if the requested action is a cloud-based action or an on-board based action; an intent parser operable to convert the natural language input text data file into a first machine readable data structure in response to the requested action being determined to be the on-board based action; and at least one skill enabled by the first machine readable data structure to perform the requested action.

The system further comprises a communication module operable to: transmit the natural language input text data file through the transceiver to the cloud-based service provider in response to the requested action being determined to be the cloud-based action; and receive a second machine readable data structure through the transceiver from the cloud-based service provider in response to the natural language input text data file.

The system further comprises a text-to-speech converter operable to convert the second machine readable data structure to a natural language output text data file; and a signal generator operable to convert the natural language output text data file to the electronic output signal.

In one or more embodiments of the system, the computing device includes a central processing unit configured to convert the voice input into the natural language input text data file with the speech-to-text converter, and analyze the natural language input text data file of the voice input with the text analyzer to determine the requested action.

In one or more embodiments of the system, the computing device is operable to recognize a plurality of wake words; and each of the plurality of wake words is a personalized word for an individual one of a plurality of users.

In one or more embodiments of the system, the computing device is operable to disable an electronic device in the vehicle in response to recognizing at least one of the wake words to prevent the electronic device from duplicating the requested action.

In one or more embodiments of the system, the computing device is operable to remove an ambient noise from the voice input with the voice model, wherein the ambient noise includes a noise present in the vehicle during operation of the vehicle.

In one or more embodiments of the system, the computing device is operable to communicate with an electronic device in the vehicle.

In one or more embodiments of the system, the computing device is operable to train the voice model through interaction with a user.

In one or more embodiments of the system, the computing device includes an Artificial Intelligence co-processor, and a processor in communication with the Artificial Intelligence co-processor.

A computer-readable medium on which is recorded instructions in provided herein. The instructions are executable by at least one processor in communication with a microphone, a speaker and a transceiver, and disposed on-board a vehicle, wherein execution of the instructions causes the at least one processor to: receive an electronic input signal from the microphone; recognize a voice input within the electronic input signal with a voice model operable on the at least one processor; convert the voice input into a natural language input text data file with a speech-to-text converter operable on the at least one processor; analyze the natural language input text data file of the voice input to determine a requested action with a text analyzer operable on the at least one processor; and determine if the requested action is a cloud-based action or an on-board based action with an action identifier operable on the at least one processor.

The execution of the instructions further causes the at least one processor to convert the natural language input text data file into a first machine readable data structure with an intent parser operable on the at least one processor in response to the requested action being determined to be the on-board based action; perform the requested action with a skill enabled by the first machine readable data structure and operable on the at least one processor in response to the requested action being determined to be the on-board based action; cause the natural language input text data file to be transmitted through the transceiver to a cloud-based service provider in response to the requested action being determined to be the cloud-based action; receive a second machine readable data structure through the transceiver from the cloud-based service provider in response to the natural language input text data file; and convert the second machine readable data structure to a natural language output text data file with a text-to-speech converter operable on the at least one processor.

The execution of the instructions further causes the at least one processor to convert the natural language output text data file to the electronic output signal with a signal generator operable on the at least one processor, wherein an acoustic output signal is generated by the speaker in response to the electronic output signal.

In one or more embodiments of the computer-readable medium, execution of the instructions further causes the at least one processor to activate a voice assistant system in response to recognizing a wake word in the electronic input signal.

In one or more embodiments of the computer-readable medium, a personalized wake phrase is defined for a user.

In one or more embodiments of the computer-readable medium, the personalized wake word for the user includes a respective personalized wake word defined for each of a plurality of users.

In one or more embodiments of the computer-readable medium, execution of the instructions further causes the at least one processor to disable an electronic device in the vehicle in response to recognizing the wake word to prevent the electronic device from duplicating the requested action.

In one or more embodiments of the computer-readable medium, converting the voice input into the natural language input text data file includes training a voice model to recognize the voice input.

In one or more embodiments of the computer-readable medium, training the voice model includes training the removal of an ambient noise from the voice input, wherein the ambient noise includes a noise in the vehicle during operation of the vehicle.

In one or more embodiments of the computer-readable medium, training the voice model includes training a plurality of different sound models, with each sound model having a different respective ambient noise.

In one or more embodiments of the computer-readable medium, performing the requested action with the skill operable on the at least one processor includes communicating with one of a cloud-based service provider or an electronic device in the vehicle.

In one or more embodiments of the computer-readable medium, execution of the instructions further causes the at least one processor to convert a third machine readable data structure into the natural language output text data file with a text-to-speech converter operable on the computing device.

A method of operating a voice assistant system of a vehicle is provided herein. The method comprises: receiving an electronic input signal into a computing device disposed on-board the vehicle; recognizing a voice input within the electronic input signal with a voice model operable on the computing device; converting the voice input into a natural language input text data file with a speech-to-text converter operable on the computing device; analyzing the natural language input text data file of the voice input to determine a requested action with a text analyzer operable on the computing device; and determining if the requested action is a cloud-based action or an on-board based action with an action identifier operable on the computing device.

The method further comprises converting the natural language input text data file into a first machine readable data structure with an intent parser operable on the computing device in response to the requested action being determined to be the on-board based action; performing the requested action with a skill enabled by the first machine readable data structure and operable on the computing device in response to the requested action being determined to be the on-board based action; transmitting the natural language input text data file to a cloud-based service provider in response to the requested action being determined to be the cloud-based action; receiving a second machine readable data structure from the cloud-based service provider in response to the natural language input text data file; and converting the second machine readable data structure to a natural language output text data file with a text-to-speech converter operable on the computing device.

The method further comprises converting the natural language output text data file to the electronic output signal with a signal generator operable on the computing device; and generating an acoustic output signal in response to the electronic output signal.

In one or more embodiments of the method, the computing device includes a central processing unit, and wherein voice recognition processing, natural language processing, text-to-speech processing, converting the voice input into the natural language input text data file, and analyzing the natural language input text data file of the voice input to determine the requested action are performed solely by the central processing unit.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic side view of a vehicle showing a vehicle cockpit system.

FIG. 2 is a flowchart representing a method of operating a voice assistant system of the vehicle cockpit system.

FIG. 3 is a schematic block diagram illustrating an aspect of the voice assistant system.

FIG. 4 is a schematic exemplary block diagram of the voice assistant system.

FIG. 5 is a schematic block diagram illustrating the architecture and operation of the voice assistant system for use with real time data.

FIG. 6 is a schematic block diagram illustrating voice assistant system training for speech recognition and speech synthesis using an owner's manual.

FIG. 7 is a schematic diagram of an Artificial Intelligence co-processor for the voice assistant system.

FIG. 8 is a schematic block diagram of an implementation of a smart voice assistant.

FIG. 9 is a schematic block diagram of an implementation of a training/inference process.

FIG. 10 is a schematic diagram of a speech inference data flow.

FIG. 11 is a schematic diagram of an implementation of a speech neural network acoustic model.

FIG. 12 is a schematic block diagram of an example implementation of a neural text-to-speech system.

FIG. 13 is a schematic block diagram of an example implementation of a Tacotron 2 neural network.

FIG. 14 is schematic block diagram of an implementation of another training/inference process.

FIG. 15 is a schematic block diagram of an example implementation of a technique for continuous improvements and updates.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

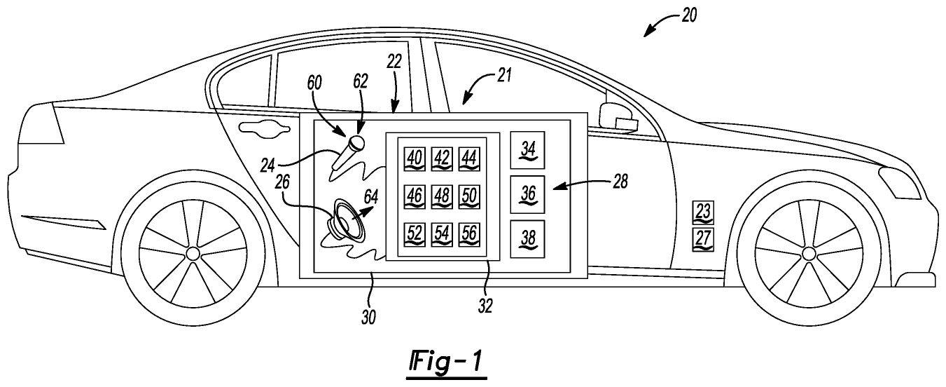

Referring to the Figures, wherein like numerals indicate like parts throughout the several views, a vehicle is generally shown at 20 in FIG. 1. The embodiment of the vehicle 20 in FIG. 1 is depicted as an automobile. However, the vehicle 20 may be embodied as some other form of moveable platform, such as but not limited to a truck, a boat, a plane, a motorcycle, a train, an airplane, etc. In some embodiments, the moveable platform may be autonomous, e.g., self-driving, or semi-autonomous.

Without the ability to control and execute onboard and off-board functions and systems through a voice assistant system, a vehicle occupant's experience may be less than optimal in terms of vehicle usability, safety, and the like. The occupant's driving experience may be enhanced by a voice assistant system that accepts natural language commands for onboard and off-board functions and systems. By training the voice assistant system to understand natural language verbal inputs, the voice assistant system dynamically recognizes and processes commands for executing control of a vehicle cockpit system. This training may be performed on the factory floor, with additional, user specific training occurring in real time (or contemporaneously) in the vehicle. In some embodiments, the voice assistant system may use dedicated hardware that powerfully performs the voice recognition functions without expending significant processing power.

The systems and operations set forth herein are applicable for use with any vehicle cockpit system. For simplicity and exemplary purposes, the various embodiments may be described herein as part of an infotainment system for a vehicle, which may be part of the vehicle cockpit system. The cockpit system includes a microphone operable to receive a voice input, and a speaker operable to generate a voice output in response to an electronic output signal. The cockpit system further includes a computing device. The computing device is disposed in communication with the microphone and the speaker. The computing device includes a speech-to-text converter that is operable to convert the voice input into a natural language input text data file, a text analyzer that is operable to determine a requested action of the natural language input text data file, an action identifier that is operable to determine if the requested action is a cloud-based action or an on-board based action, at least one skill that is operable to perform a defined function, an intent parser that is operable to convert the natural language input text data file into a machine readable data structure, a voice model that is operable to recognize the voice input when the voice input is combined with an ambient noise, a text-to-speech converter that is operable to convert a machine readable data structure to a natural language output text data file, and a signal generator that is operable to convert the natural language output text data file to the electronic output signal for the speaker.

The computing device inputs a voice input from the microphone, and converts the voice input into the natural language input text data file with the speech-to-text converter. The text recognized in the voice input may be presented on a screen (or display) to the speaker (or user) as feedback indicating what was heard by the computing device. The computing device then analyzes the natural language input text data file of the voice input with the text analyzer to determine a requested action, and determines if the requested action is a cloud-based action or an on-board based action, with the action identifier. When the requested action is determined to be a cloud-based action, the computing device communicates the natural language input text data file to a cloud-based service provider for completion without waiting for additional commands from the user. When the requested action is determined to be an on-board based action, the computing device executes the requested action with the skill to perform the requested action without waiting for additional commands from the user. Additionally, the computing device may convert a natural language output text data file to the electronic output signal, and output a voice output with the speaker in response to the electronic output signal.

The operation of the voice assistant system of the vehicle may include inputting a voice input into a computing device disposed on-board the vehicle. The voice input is converted into a text data file with a speech-to-text converter that is operable on the computing device. The text data file of the voice input is analyzed, to determine a requested action, with a text analyzer that is operable on the computing device. An action identifier operable on the computing device then determines if the requested action is a cloud-based action or an on-board based action. When the requested action is determined to be a cloud-based action, the computing device communicates the text data file to a cloud-based service provider. When the requested action is determined to be an on-board based action, then the computing device executes the requested action with a skill operable on the computing device to perform the requested action.

Accordingly, the infotainment system of the vehicle uses the voice model to convert the voice input into the natural language input text data file. In one aspect, the voice model is trained to recognize natural language voice inputs that are combined with common ambient noises often encountered in a vehicle. In another aspect, the voice model is trained to recognize natural language commands. In yet another aspect, the voice model is trained to recognize the natural language commands input with different dialects, accents, speech patterns, etc. The voice model may also be trained in real time (or contemporaneously) to better understand the natural language specific to the user. As such, the voice model provides a more accurate conversion of the voice input into the natural language input text data file. The infotainment system then identifies the requested action included in the voice input, and determines if the requested action may be executed by an on-board skill, or if the requested action indicates an off-board service provider accessed through the internet. In some embodiments, the actions may be performed on-board and off-board.

More particularly, the above steps are performed on-board the vehicle, and ultimately the on-board computing device determines if the requested action may be executed with an on-board skill, or if the requested action indicates an offboard service provider. As one non-limiting example, the voice assistant system maintains operability as to the on-board based actions, and may perform such on-board based actions regardless of the presence of an internet connection. In some embodiments, the voice assistant system may determine that certain actions are performed better or more optimally on-board than off-board (or vice-versa). In other embodiments, only the requested actions that utilize an off-board service provider are communicated from the vehicle to the internet, whereas requested actions that can be handled by the on-board skills of the vehicle are not communicated from the vehicle to the internet, and are instead handled by the on-board vehicle systems. As a result, the voice assistant system uses intelligence and logic (as further described below) to determine the optimal execution path, e.g., on-board, off-board, or a combination of both, for performing the user requested action.

Additionally, the infotainment system may be programmed with a personalized wake word for each respective user. By doing so, the user may wake the infotainment system of the vehicle to execute the requested action, without simultaneously waking another electronic device, such as a smart phone, tablet, etc., which may also be in the vehicle. This reduces duplication of the requested action. In situations where the infotainment system is busy responding to a requested action, recognition of the wake word may suspend or end the current requested action in favor of a new requested action. In various embodiments, the infotainment system may complete the current requested action in the background while beginning service of the new requested action.

In some embodiments, the wake word may be defined to include a well-known wake word or phrase, e.g., “Ok Google”™, or by referring to the voice assistant system by a popularized name, such as “Siri”®. In additional or alternative embodiments, the wake word may be customized by the user(s), which, in some embodiments, the voice assistant system learns based on training performed by the vehicle user. “Ok Google”′ is a trademark of Google LLC. Siri® is a registered trademark of Apple, Inc.

In additional or alternative embodiments, there may be multiple wake words for different devices and/or different user requested actions. The voice assistant system may be woke by the commonly used wake word, but still makes the determination as to whether the requested action is a cloud-based action or an on-board based action with the on-board action identifier. Accordingly, if the action identifier determines that the requested action is an on-board based action, the computing device may execute the requested action with an on-board skill, even though the wake word is a commonly used wake word that would otherwise automatically trigger a cloud-based action. For example, the user may say “Siri®, turn on the car heater.” While the wake word Siri® would normally cause a Cloud based response, the action identifier may determine that the requested action to turn on the car heater is an on-board based action, and execute the requested action with an on-board skill. The various embodiments offer at least one advantage in that the use of the voice assistant system is seamless for the user.

In some embodiments, the computing device may be equipped with a graphic processing unit and/or neural processing unit, in combination with a central processing unit. Certain processes of the method described herein may be assigned to the graphic processing unit and/or the neural processing unit, in order to offload work from the central processing unit to provide a faster result. In other embodiments, the computing device may be equipped with an Artificial Intelligence (AI) co-processor, in combination with the central processing unit. The AI co-processor provides the voice recognition/voice synthesis and real time/contemporaneous learning capabilities for the voice assistant system.

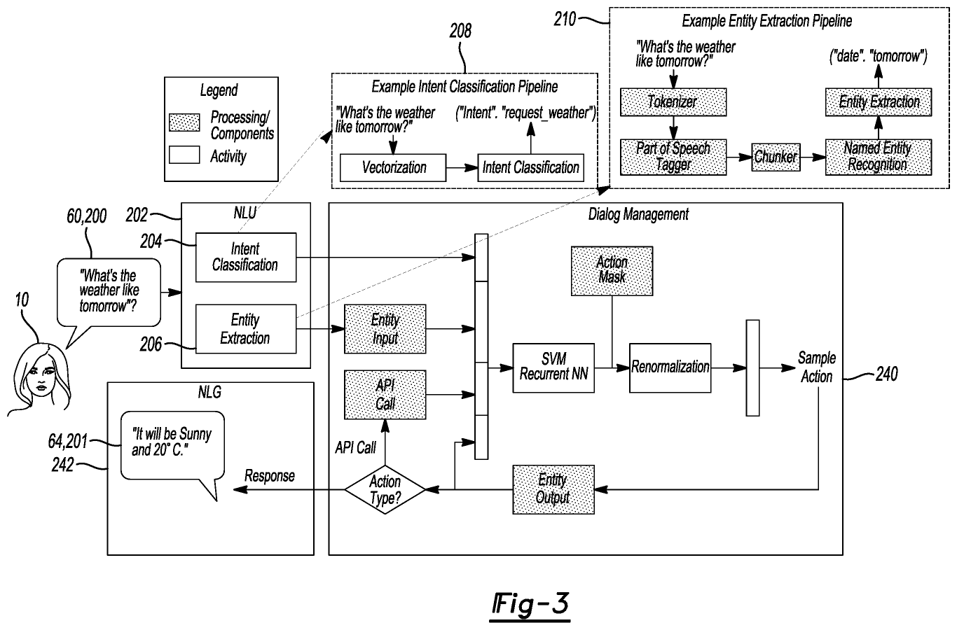

Referring to FIG. 1, the vehicle 20 includes a cockpit system 21. The cockpit system 21 provides one or more users 10 (see FIG. 3) access to entertainment, information, and control systems of the vehicle 20. The cockpit system 21 may include an infotainment system 22, one or more domain controllers, instrument clusters, vehicle controls such as HVAC controls, speed controls, brake controls, etc. The infotainment system 22 may include, but is not limited to, a microphone 24, a speaker 26, and a computing device 28. The microphone 24 is disposed in communication with the computing device 28. The microphone 24 is operable to receive a voice input within an acoustic input signal 60, and convert the voice input/acoustic input signal 60 into an electronic input signal for the computing device 28. The microphone 24 may also receive acoustic noise 62 from the ambient environment. The speaker 26 is in communication with the computing device 28. The speaker 26 is operable to receive an electronic output signal from the computing device 28, and generate a voice output in an acoustic output signal 64 from the electronic output signal.

In one or more embodiments, the infotainment system 22 may further include a voice assistant system 30. In other embodiments, the voice assistant system 30 may be independent of the infotainment system 22. In one aspect, the voice assistant system 30 provides the user 10 a convenient and user friendly device for verbally controlling one or more components/systems of the cockpit system 21. In other embodiments, the voice assistant system 30 provides the user 10 access to off-board services. The operation of the voice assistant system 30 is described in greater detail below.

The computing device 28 may alternatively be referred to as a controller, a control unit, etc. The computing device 28 is operable to control the operation of the voice assistant system 30. In an example where there are multiple voice assistant systems 30, which may be the same or different systems or a combination of the same and different systems, the computing device 28 may include a determination logic for determining which voice assistant system to use. The voice assistant system 30 may determine an appropriate cloud-based voice assistant or an appropriate service, based on the nature and context of the utterance of the user 10, e.g., the voice input. For example, if the voice input is a general search request, the determination logic may determine that the requested action be directed to Google, whereas if the voice input is an e-commerce request, the determination logic may determine that the requested action is better serviced by Alexa™ Voice Service (AVS). Alexa™ is a trademark of Amazon.com, Inc. The determination of which service to use may not be pre-defined or pre-determined. Rather, the voice assistant system's 30 logic may be configured to determine the best service dynamically based on multiple factors, including but not limited to, the type of request, the availability of the service, relevancy of data results, user preferences, and the like. It is understood that the factors are provided for exemplary purposes only, and that a number of additional or alternative factors may be used in operation of the voice assistant system 30.

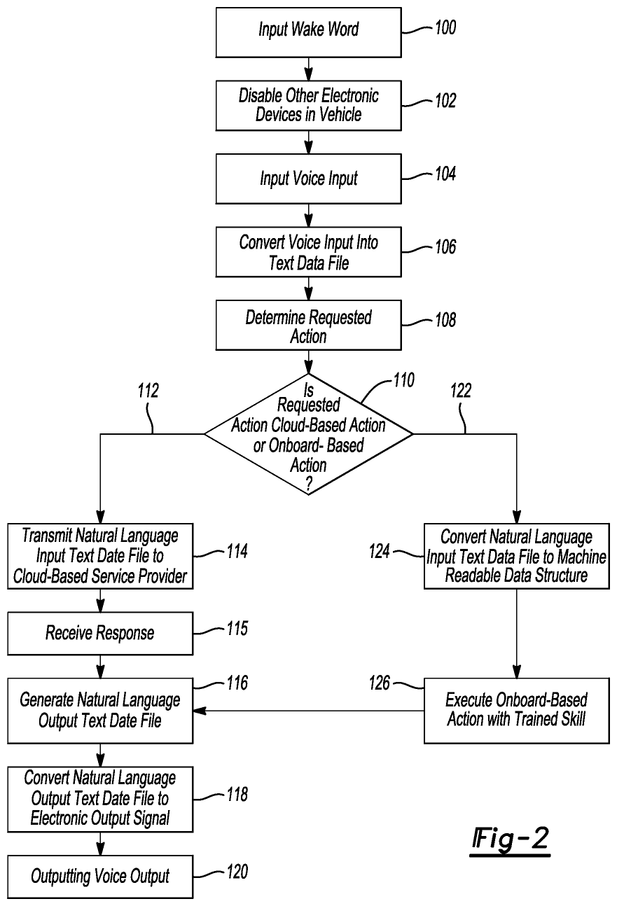

The computing device 28 may include one or more processing units 34, 36, 38, and may include software, hardware, memory, algorithms, connections, sensors, etc., suitable to manage and control the operation of the voice assistant system 30. Described below and generally shown in FIG. 2 is the operation of the voice assistant system 30 using one or more programs or algorithms operable on the computing device 28. It should be appreciated that the computing device 28 may include any device capable of analyzing data from various sensors, inputs, etc., comparing data, making the decisions appropriate to control the operation of the voice assistant system 30, and executing the tasks suitable to control the operation of the voice assistant system 30.

The computing device 28 may be embodied as one or multiple digital computers or host machines each having one or more processing units 34, 36, 38 and computer-readable memory 32. The computer readable memory may include, but is not limited to, read only memory (ROM), random access memory (RAM), electrically-programmable read only memory (EPROM), optical drives, magnetic drives, etc. The computing device 28 may further include a high-speed clock, analog-to-digital (A/D) circuitry, digital-to-analog (D/A) circuitry, and any supporting input/output (I/O) circuitry, I/O devices, and communication interfaces, as well as signal conditioning and buffer electronics.

The computer-readable memory 32 may include any non-transitory/tangible medium which participates in providing data and/or computer-readable instructions. Memory may be non-volatile and/or volatile. Non-volatile media may include, for example, optical or magnetic disks and other persistent memory. Example volatile media may include dynamic random access memory (DRAM), which may constitute a main memory. Other examples of embodiments for memory include a floppy, flexible disk, or hard disk, magnetic tape or other magnetic medium, a compact disc read-only memory (CD-ROM), a digital versatile disc (DVD), and/or any other optical medium, as well as other possible memory devices such as flash memory.

The computer-readable memory 32 of the computing device 28 includes tangible, non-transitory memory on which are recorded computer-executable instructions. The processing units 34, 36, 38 of the computing device 28 are configured for executing the computer-executable instructions to operate the voice assistant system 30 of the infotainment system 22 on the vehicle 20. The computer-executable instructions may include, but are not limited to, the following algorithms/applications which are described in greater detail below: a speech-to-text converter 40 including a voice model 54, a text analyzer 42, an action identifier 44, at least one skill 46, an intent parser 48, a text-to-speech converter 50, and a signal generator 52.

In one or more embodiments, the user 10 may speak the voice input in a natural language format. As such, the voice input may be referred to as a natural language voice input. The user 10 does not have to speak a pre-defined, specific command to produce a specific result. Rather, the user 10 may use the terminology and/or vocabulary that they would normally use to make the request, e.g., the natural language voice input. The speech-to-text converter 40 is operable to convert the natural language voice input into a text data file, and particularly, a natural language input text data file. As noted above, the microphone 24 receives the voice input from the user 10, and converts the voice input into an electronic input signal. The speech-to-text converter 40 converts the electronic input signal from the microphone 24 into a natural language input text data file. The speech-to-text converter 40 may be referred to as automatic speech recognition software, and converts the spoken words of the user 10 into the text data file. In order to accurately recognize the verbal words of the natural language voice input, the speech-to-text converter 40 may be trained or programmed with a voice model 54. The voice model 54 includes multiple different speech patterns, accents, dialects, languages, vocabulary, etc., and enables the speech-to-speech converter 40 to correlate a verbal sound with a textual word. The language(s) used in the natural language voice input may include, but are not limited to, English, French, Spanish, German, Portuguese, Indian English, Hindi, Bengali, Mandarin, Arabic and Japanese. Programming the voice model 54 is described in greater detail below.

In one or more embodiments, the voice model 54 may be specifically trained and can learn to recognize words, phrases, instructions, etc., from text based information relating to the vehicle or vehicle components. For example, the text based information may be an owner's manual, an operator's manual, or a service manual specific to the vehicle 20, a component of the vehicle 20 and/or settings in the vehicle 20. As another non-limiting example, the text based information may be a list of radio stations. For purposes of each explanation, such training of the voice model 54 for natural language understanding will be described using an owner's manual as the example. However, it should be appreciated that the teachings of the disclosure may be applied to other manuals and/or text based information. The owner's manual may be digitally input into a voice training system and then processed and stored in a manner such that specific onboard commands can be recognized using natural language commands. In some embodiments, the voice assistant system 30 can learn to process commands without regard to a difference in voice between speakers due to an accent, intonation, speech pattern, dialect, etc. For example, the voice model 54 may include voice recordings of the vehicle owner's manual, which includes terms, phrases, terminology that are specific to the vehicle, with different speech patterns, accents, dialects, languages, etc. This voice training of the voice model 54 for the owner's manual enables quicker and more accurate recognition of the vocabulary and terminology specific to the vehicle 20.

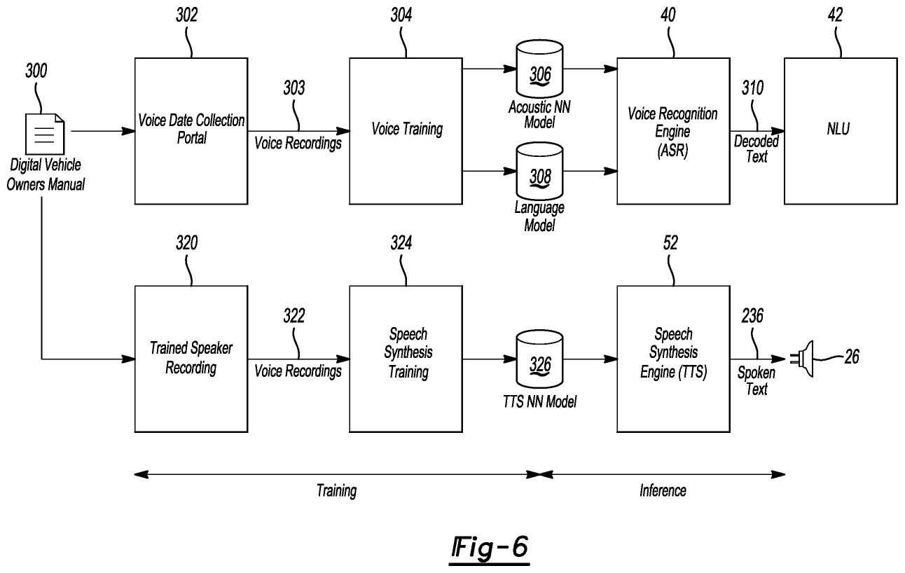

Referring to FIG. 6, additional details regarding the training of the voice model 54 are described in greater detail. As shown in FIG. 6, the owner's manual is input into the system, for example, by inputting a digital version of the vehicle's manual for the system to “read”. The digital version of the owner's manual is generally shown at 300. The owner's manual may be read into a voice data collection portal 302 by a voice recording. The voice recording may be either a human voice recording or a computer generated voice recording. The process may be repeated with different voice recordings of the owner's manual using different accents, speech patterns, dialects, etc. Voice recordings 303 are generated from the owner's manual input into the data collection portal 302. Voice training occurs in box 304 to develop an acoustic neural network model 306 and a language model 308. The acoustic neural network model 306 learns how words and phrases in the owner's manual sound. The acoustic neural network model 306 accounts for variations in utterances, dialects, and other speech patterns for specific words and/or phrases. Through building a robust acoustic neural network model 306, the applicability of the voice model 54 increases, because the pool of viable users 10 increases. This allows the system to understand a wider array of people, and eliminates the issue where the voice model 54 only understands or recognizes a person from one region, even though other regions may be speaking the same language, albeit with different utterances, dialects, or other speech patterns.

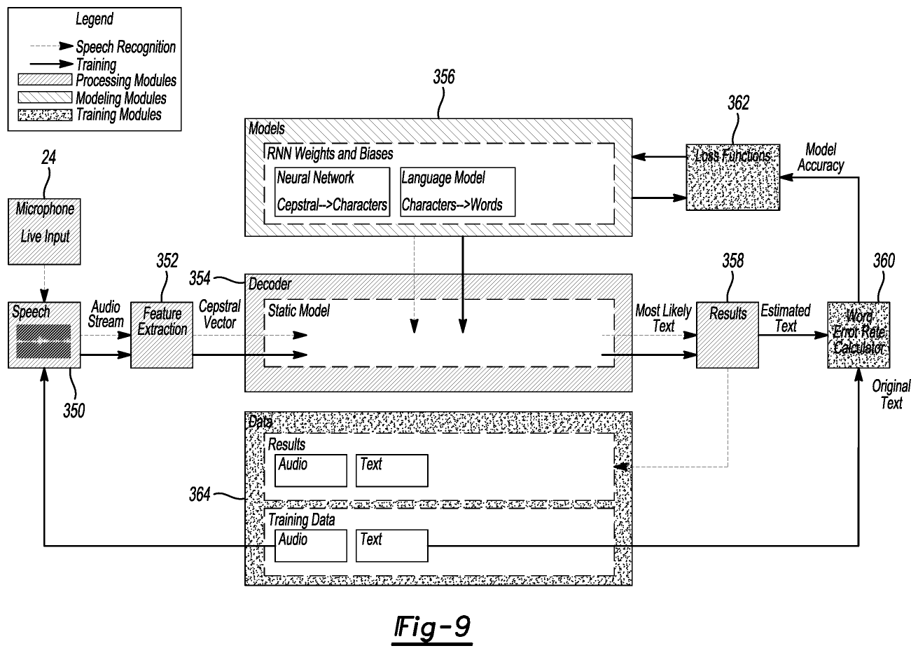

The language model 308 learns the specific words, phrases, terminology, etc., associated with the owner's manual. From that, the voice model 54 will be able to recognize when a user 10 speaks those words and phrases that are specific to the owner's manual and/or vehicle 20. Furthermore, the voice model 54 will be able to understand what those words and phrases mean. The acoustic neural network model 306 and the language model 308 enables voice model 54 of the speech-to-text converter 40, which converts the voice input of the user 10 into the natural language input text data file. The text analyzer 42 (described in greater detail below), then determines a requested action of the natural language input text data file. FIG. 9 graphically illustrates the training flow of training the speech-to-text converter 40 and the voice model 54 for improving and/or training voice recognition.

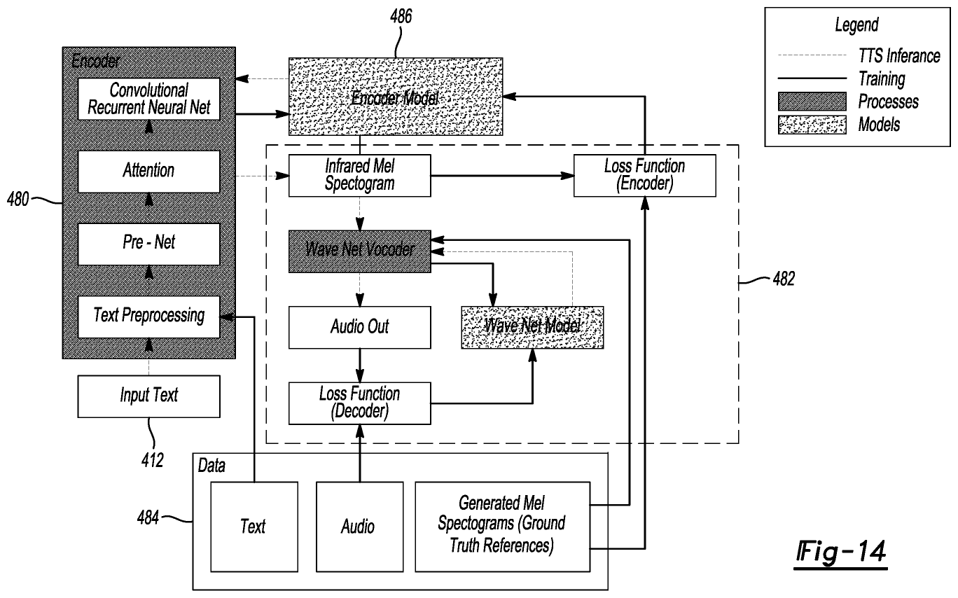

Continuing on with reference to FIG. 6, the owner's manual 300 may be read into a speaker recording portal 320 by a voice recording. The voice recording may be either a human voice recording or a computer generated voice recording. The process may be repeated with different voice recordings of the owner's manual using different accents, speech patterns, dialects, etc., such that the voice assistant system 30 learns a wide array of dialects and pronunciations for the same words. Voice recordings 322 are generated from the owner's manual input into the speaker recording portal 320. Speech synthesis training occurs in box 324 to develop a text-to-speech neural network model 326. Through developing the text to speech neural network model 326, the voice assistant system 30 learns how words and phrases in the owner's manual sound, and because of that, the voice assistant system 30 learns how to more accurately pronounce words in the owner's manual. Moreover, the output pronunciation of the system may be tailored to regional speech patterns, utterances, dialects, etc. This may promote usage of the voice assistant system 30, because the user 10 may feel as though the voice assistant system 30 has assimilated to the surrounding region, as opposed to sounding like an outsider. The signal generator 52 uses the text-to-speech neural network model 326 to convert an output response into an electronic output signal 236, which is broadcast by the speaker 26. FIG. 14 graphically illustrates the training flow of training the text-to-speech converter 50 for improving and/or training voice synthesis.

The text analyzer 42 is operable to determine a requested action of the natural language input text data file, which is generated by the speech-to-text converter 40 using the voice model 54, after the user 10 speaks a command as described above. The text analyzer 42 examiners the natural language input text data file to determine the requested action. The requested action may include for example, but is not limited to, a request for directions to a desired destination, a request for a recommended destination, a request to make an online purchase, a request to control a vehicle system, such as but not limited to a radio or heating, ventilation, and air conditioning (HVAC) system, a request for a weather forecast, etc. The text analyzer 42 may include any system or algorithm that is capable of determining the requested action from the natural language input text data file of the voice input.

An exemplary embodiment of the text analyzer 42 is schematically shown in FIG. 3. Referring to FIG. 3, a voice input 200 spoken by the user 10 and converted into a natural language input text data file (by the speech-to-text converter 40) is generally shown. A natural language understanding unit (NLU) 202 analyzes the natural language input text data file with an intent classifier 204 to determine a classification of the requested action, and an entity extractor 206 to identify keywords or phrases. In the exemplary embodiment shown in FIG. 3, the natural language input text data file includes the requested action “What's the weather like tomorrow?” As shown in box 208, the intent classifier 204 analyzes the data file, and may determine that the classification of the requested action is to “request weather forecast.” As shown in box 210, the entity extractor 206 may analyze the data file, and determine or identify the keyword or entity “tomorrow.” The intended classification “request weather”, and the extracted entity “tomorrow”, are passed on to a manager 240, which uses the action identifier 44 and the programmed skills 46 to execute the requested action, such as described in greater detail below. A response signal may be generated by the manager 240 and presented to the natural language generation (NLG) software 242. The natural language generation software 242 may create the electronic output signal 236 that the speaker 26 converts into the voice output 201 (e.g., “It will be sunny and 20° C.”) within the acoustic output signal 64.

In one or more embodiments, the text analyzer 42 may use real time on-board and/or off-board data to determine a requested action and/or provide a suggested action to the user 10. For example, the real time data may include real time vehicle operation data, such as but not limited to fuel/power levels, powertrain operation and/or condition, etc. The real time data may also include real time user specific data, such as but not limited to user's preferences, a user's personal calendar, a user's destination, etc. In addition, the real time data may further include real time off-board data as well, such as but not limited to current weather conditions, current traffic conditions, recommended services, etc. The real time data may be input into the text analyzer 42 from several different inputs, such as but not limited to different vehicle sensors, vehicle controllers or units, personal user devices and settings, the cloud or other internet sources, etc.

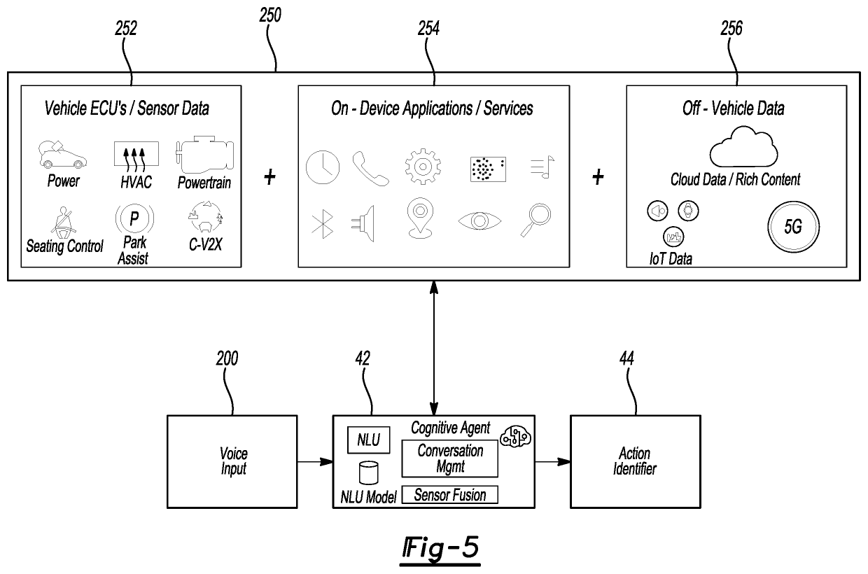

Referring to FIG. 5, the unstructured real time data 250 from the various different sources may be bundled into different groupings to define different real time data contexts. For example, the vehicle specific data may be grouped into a vehicle context 252, the user specific data may be grouped into a user context 254, and the off-board data may be grouped into a world context 256. These different contexts may then be considered or reference by the text analyzer 42 to determine the requested action, or provide a suggested action.

The action identifier 44 is operable to determine if the requested action is a cloud-based action or an on-board based action. The action identifier 44 includes logic that determines if the requested action is a cloud-based action or an on-board based action. Additionally, for requested actions that may be either an on-board based action or a cloud-based action, the action identifier 44 includes logic that prioritizes the determination of the on-board based action or the cloud-based action. As used herein, a cloud-based action is a requested action that may be performed or executed with a remote cloud or over the internet service. In other words, the cloud-based action is a requested action that the computing device 28 is not capable of fully performing with the various systems and algorithms available in the vehicle 20. For example, if the requested action is a request to purchase an item from an on-line retailer, the computing device 28 can only complete the requested action by connecting with the on-line retailer via the internet. Accordingly, such a request may be considered a cloud-based action. The off-board based action may also be, as other non-limiting examples, requesting contact book information stored off-board, making a reservation at a restaurant, or scheduling vehicle maintenance at a service facility. It will be appreciated that the foregoing are only examples and other off-board based actions may be performed using the various embodiment's described herein.

As used herein according to one or more non-limiting embodiments, an on-board based action is a requested action that may be performed or executed using the systems and/or algorithms available on the vehicle 20. In such an embodiment, an internet connection is not applicable. However, such actions may still be performed wirelessly using techniques now or later known in the art. In other words, an on-board based action is a requested action that the computing device 28 may complete without connecting to the internet. For example, a request to change the station on a radio of the vehicle 20, or a request to change a cabin temperature of the vehicle 20, may be fully executed by the computing device 28 using the embedded logic and the systems available on the vehicle 20, and may therefore be considered an on-board based action.

As noted above, the computing device 28 includes at least one skill 46 that is operable to perform a defined function. As used herein in accordance with one or more embodiments, a skill 46 may be considered a function that the computing device 28 has been defined or programmed to perform or execute. The skill 46 may alternatively be referred to as a programmed skill or a trained skill. The skill 46 may include a specific vehicle system that is programmed to perform or execute the defined function or task. The skill 46 may include custom logic that an original equipment manufacturer (OEM) or end user programs to connect the voice assistant system 30 with any on-board or cloud service which services the requested action that the user 10 makes via the voice input. As one non-limiting example, a skill 46 may include, but is not limited to, controlling the HVAC system of the vehicle 20 to change the cabin temperature of the vehicle 20. In another non-limiting embodiment, the skill 46 may include controlling the radio of the vehicle 20 to change the volume or change the station. It will be appreciated that the foregoing are merely examples and other numerous other on-board actions are contemplated. While some skills 46 may be performed on-board the vehicle 20, other skills 46 may include off-board actions, e.g., connecting to the internet or a mobile phone service to complete a function. As one non-limiting example, the computing device 28 may be defined to include a skill 46 for making a reservation at a pre-defined restaurant. The skill 46 may be defined to connect with a mobile phone device of the user 10, and call a pre-programmed phone number for the restaurant in order to make a reservation. In this case, the skill 46 is executed on-board the vehicle 20, but involves the computing device 28 using an off-board service, e.g., the mobile phone service, to complete the requested action. This differs from a cloud-based action in that the skill 46 is defined to connect to a specific website to perform a specific function, whereas a cloud-based action is a request made to the internet, such as a search request, in which the specific website and results are not defined.

The intent parser 48 is operable to convert the natural language input text data file into a machine readable data structure. The machine readable data structure may include, but is not limited to, JavaScript Object Notation (JSON) (ECMA International, Standard ECMA-404, December 2017) The computing device 28 uses the machine readable data structure to enable one or more of the skills 46.

The text-to-speech converter 50 is operable to convert a machine readable data structure to a natural language output text data file. The text-to-speech converter 50 may be referred to as the natural language generation (NLG) software, and converts the machine readable data structure into natural language text. The natural language generation software is understood by those skilled in the art, is readily available, and is therefore not described in greater detail herein.

The signal generator 52 is operable to convert the natural language output text data file from the text-to-speech converter 50 into the electronic output signal for the speaker 26. As noted above, the speaker 26 outputs sounds based on the electronic output signal. As such, the signal generator 52 converts the natural language output text data file into the electronic signal that enables the speaker 26 to output the words of the output signal.

In various embodiments, one or more of the skills 46, the entity extractor 206 and/or the cloud-based services 228 may be operable to generate the machine readable data structure to be compatible with different languages. Therefore, the natural language text generated by the text-to-speech converter 50, the signal generator 52 and the acoustic output signal 64 created by the speaker 26 may be in a requested language. For example, the user 10 may ask, “What does the French phrase ‘regatta de blanc’ mean in English?” In response to the question, the action identifier 44 in the voice assistant system 30 may determine that a cloud-based language translation is appropriate. The French phrase may be translated into an English phrase at a natural language understanding (NLU) backend using a standard technique and returned to the voice assistant system 30. The text-to-speech converter 50, the signal generator 52 and the speaker 26 may provide the requested translation to the user 10 in the English language.

In one embodiment, the computing device 28 includes a Central Processing Unit (CPU) 34, and at least one of a Graphics Processing Unit (GPU) 36 and/or a Neural Processing Unit (NPU) 38. Briefly stated, the CPU 34 is a programmable logic chip that performs most of the processing inside the computing device 28. The CPU 34 controls instructions and data flow to the other components and systems of the computing device 28. The GPU 36 is a programmable logic chip that is specialized for processing images. In various embodiments, the GPU 36 may be more efficient than the CPU 34 for algorithms where processing of large blocks of data is done in parallel, such as processing images. The NPU 38 is a programmable logic chip that is designed to accelerate machine learning algorithms, in essence, functioning like a human brain instead of the more traditional sequential architecture of the CPU 34. The NPU 38 may be used to enable Artificial Intelligence (AI) software and/or applications. The NPU 38 is a neural processing unit specifically meant to run AI algorithms. In some designs, the NPU 38 may be faster and may be more power-efficient when compared to a CPU or a GPU.

Because portions of the process described herein involve large blocks of speech data, such as but not limited to converting the voice input into the natural language input text data file, execution of those portions of the process may be assigned to the GPU 36 and/or the NPU 38, if available. For example, in one or more embodiments, voice recognition processes, natural language processing, text-to-speech processing, a process of converting the voice input into a text data file, and/or a process of analyzing the text data file of the voice input to determine the requested action therein may be performed by at least one of the GPU 36 or the NPU 38. By doing so, the processing demand on the CPU 34 is reduced. Additionally, because the GPU 36 and/or the NPU 38 are programmed to process images faster and more efficiently than the CPU 34, the GPU 36 and/or the NPU 38 may perform these operations more quickly than the CPU 34. Accordingly, the process described herein utilizes the GPU 36 and the NPU 38 in a non-traditional fashion, e.g., for speech recognition and voice assistant functions. In various embodiments, the voice recognition processes, the natural language processing, the text-to-speech processing, the process of converting the voice input into a text data file, and the process of analyzing the text data file of the voice input to determine the requested action may be assigned solely to the CPU 34. For example, the processing may be assigned to one or two cores of a multi-core CPU 34. As a result, a size and power consumption of the speech processing circuitry may be reduced.

As noted above, the CPU 34, the GPU 36 and/or the NPU 38 may include neural networks that utilize deep learning algorithms, which makes it possible to run speech recognition/synthesis on-board the vehicle. This reduces latency by not exporting these functions off-board to internet based service providers, addresses privacy concerns of the user 10 by not broadcasting recordings of their voice inputs over the internet, and reduces cost. By using the GPU 36 and/or the NPU 38 to perform at least some of the functions, the process may obtain quicker inferences and provide good run-time performance relative to using only the CPU 34. The GPU 36 and the NPU 38 include multiple physical cores which allow parallel threads doing smaller tasks to run at the same time by allowing parallel execution of multiple layers of a neural network, thereby improving the speech recognition and speech synthesis inference times when compared to a CPU.

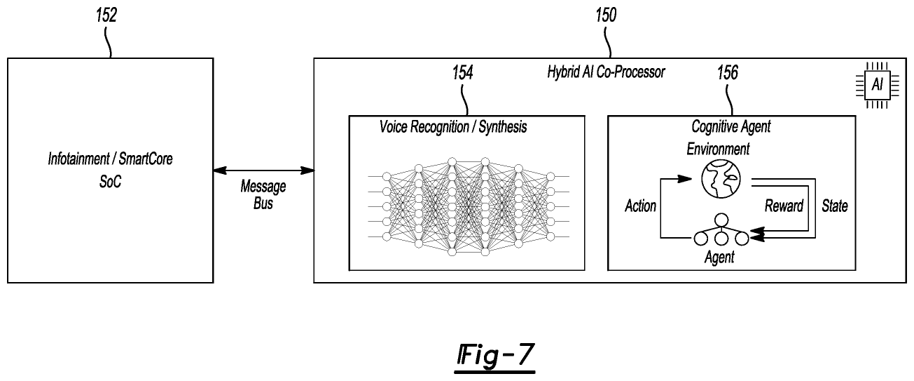

Alternatively, referring to FIG. 7 in one or more embodiments, the computing device 28 may include an AI co-processor 150 that operates jointly with a second processor 152. The AI co-processor 150 provides supervised learning for the voice recognition and voice synthesis functions of the voice assistant system 30, as well as reinforcement learning to provide real time learning capabilities for the voice assistant system 30 to build intelligence into the voice assistant system 30. The various models of the voice assistant system 30, such as but not limited to the acoustic neural network model 306, the language model 308, and the text-to-speech neural network model 326 (shown in FIG. 6) may be stored in flash memory of the AI co-processor 150 and loaded into RAM during run time. Additionally, voice recognition engines and voice synthesis engine, as well as reinforcement learning data, may also be stored in the flash memory of the AI co-processor 150.

In general, AI processors are better at supervised learning processes, and are generally not as well suited for reinforcement learning processes, which involve decision making at the edge in real time. The AI co-processor 150 of the voice assistant system 30 improves the decision making capabilities relative to other AI processors by deploying an agent based computing model which scales beyond a Tensor Processing Unit (TPU), by having agents built with multiple tensors interconnected and operating in parallel on instructions provided to them to speed up the decision making process.

The second processor 152 may include, for example the CPU 34 and/or another type of integrated circuit. In some embodiments, the second processor 152 may be implemented as a system on a chip (SoC). The second processor 152 may be part of a domain controller, may be part of another system, such as the infotainment system 22, or may be part of some other hardware platform that includes the AI co-processor 150. The AI co-processor 150 may communicate with the second processor 152. The second processor 152 may communicate with the AI co-processor 150. The AI co-processor 150 may be configured to perform the voice recognition and voice synthesis functions of the voice assistant system 30 described above, as well as reinforcement learning for the voice assistant system 30.

In real-time, the user 10 may interact with the voice assistant system 30, such as by speaking a request, e.g., the voice input. Through reinforcement learning, the voice assistant system 30 learns whether its responses to the voice input were correct or incorrect. As part of reinforcement learning, the voice assistant system uses a process of rewarding the system for correct responses, and punishing the system for incorrect responses. The reinforcement learning allows the voice assistant system to learn beyond the baseline training or understanding with which the voice assistant system 30 is originally installed and trained with. This reinforcement learning may tailor the voice assistant system 30 to a particular user 10, such as by learning the user's common vernacular. For example, voice assistant system 30 may learn that the user 10 refers to non-alcoholic, carbonated beverages with the term “pop” instead of “soda”. As another example, the voice assistant system 30 may learn that the user 10 pronounces the word “soda” with a strong “e” sound, instead of a soft “a” sound, e.g., “sodee” instead of “soda”.

As noted above, the AI co-processor 150 may be configured to perform the reinforcement learning, as well as the voice recognition and voice synthesis. As such, the AI co-processor 150 may be partitioned to include a first partition 154 and a second partition 156. The first partition 154 may be configured to perform the voice recognition and voice syntheses functions of the voice assistant system 30. The second partition 156 may be configured to perform the reinforcement learning of the voice assistant system 30.

As noted above, the voice model 54 is operable to recognize and/or learn the sounds of the natural language voice input, and correlate the sounds to words, which may be saved as text in the natural language text data file. If the voice model 54 is unable to recognize a specific sound or word of the natural language voice input, the speech-to-text converter 40 and the voice model 54 may be trained through interaction with the user 10 to learn and/or define the specific sound. As one example, in order to do this, the voice model 54 may be capable of recognizing a specific sound in the voice input when that sound in the voice input is combined with the ambient noise 62. Because the voice assistant system is used by the computing device 28 in the vehicle 20, the voice model 54 may be trained or programmed to identify sounds in combination with ambient noise 62 typically encountered within the vehicle 20. This is because the voice input includes the voice from the user 10, but also any ambient noise 62 present at the time the user 10 verbalizes the voice input. The different ambient noises 62 may include, but are not limited to, different amplitudes and/or frequencies road noise, wind noise, engine noise, or other noise, such as from other systems that may typically be operating in the vehicle 20, such as a blower motor for the HVAC system. By training or programming the voice model 54, e.g., and without limitation, using artificial intelligence (such as machine or deep learning), to recognize sounds in combination with common ambient noises 62 associated with operation of the vehicle 20, the voice model 54 provides a more accurate and robust recognition of the voice input.

To distinguish voice commands from ambient sounds, as an example, the voice model 54 may remove the ambient noise 62 from the voice input. This may be done at a signal-level. While the ambient noise 62 may be present in the vehicle 20, the voice model 54 may identify the ambient noise 62 at a signal level, along with the voice signal. The voice model 54 may then extract the voice signal from the ambient noise 62. Because of the ability to differentiate the ambient noise 62 from the voice signal, the voice model 54 is able to more accurately recognize the voice input. In some embodiments, to recognize the ambient noise 62 from the voice input, the voice model 54 may utilize machine learning. As an example, the voice model 54 may be trained through one or more deep learning algorithms (or techniques) to learn to identify ambient noise 62 from the voice input. Such training may be done through techniques known now or in the future.

In one or more embodiments, because the voice assistant system 30 is used by the computing device 28 in the vehicle 20, the voice model 54 may be programmed to identify sounds that are specific to using and operating the vehicle 20. For example, the voice model 54 may include voice recordings of the owner's manual, operator's manual, and/or service manual specific to the vehicle 20. The owner's manual, operator's manual, and/or service manual specific to the vehicle 20 may hereinafter be referred to as the manuals of the vehicle 20. The terminology included in the manuals of the vehicle 20 may not be included in the sound recordings of common words otherwise used by the voice model 54. The manuals specific to the vehicle 20 may include language and/or terminology that may be specific to the vehicle 20. The manuals of the vehicle 20 may identify specialized features, controls, buttons, components, control instructions, etc. For example, the manuals of the vehicle 20 may include trade names of systems and/or components that are not commonly used in everyday language, and/or that were specifically developed for that vehicle, such as but not limited to “On-Star”® or “Stabilitrak” ® by General Motors, or “AdvanceTrac® Electronic Stability Control” by Ford. On-Star® is a registered trademark of OnStar, LLC. Stabilitrak® is a registered trademark of General Motors, LLC. AdvanceTrac® is a registered trademark of Ford Motor Company. Similar to recordings of other sounds that the voice model 54 uses to correlate the sounds of the voice input to words, the voice recordings of the manuals specific to the vehicle 20 may include different speech patterns, accents, dialects, languages, etc. By including the voice recordings of the manuals of the vehicle 20 in the different speech patterns, accents, dialects, etc., in the voice model 54 used to convert the voice input into words, the voice assistant system 30 will better understand and be able to identify the specialized words specific to the vehicle 20, that the voice model 54 may not otherwise recognize. By so doing, the interaction between the user 10 and the voice assistant system 30 is improved.

As noted above, if the voice model 54 is unable to recognize a specific sound or word of the natural language voice input, the speech-to-text converter 40 and the voice model 54 may be trained through interaction with the user 10 to learn and/or define that specific sound for future use. The voice model 54 may be trained as part of the reinforcement learning process described above, or through some other process. As an example, if the user 10 utters the voice input “Direct me to the nearest MickyDee's”, referring to a McDonald's® restaurant, the voice model 54 may not recognize the word “MickyDee's”. McDonald's® is a registered trademark of McDonald's Corporation. However, the voice assistant system may recognize that the user 10 wants directions somewhere, based in the initial part of the request “Direct me to the nearest.” Accordingly, the voice assistant system 30 may search for words that are the most similar and/or the most likely result. The voice assistant system 30 may then follow up with a question to the user 10 stating “I do not understand where you want to go. Do you want to go to nearest McDonald's® restaurant?” Upon the user 10 verifying that the nearest McDonald's® restaurant is their desired location, the voice assistant system 30 may update the voice model to reflect that the user 10 refers to McDonald's® restaurant as “MickyDee's”. As such, the next time the user makes the request, the voice assistant system will understand the user's meaning of the word “MickyDee's”. By so doing, the user 10 is able to update the voice assistant system through interaction with it, thereby improving the experience with the voice assistant system over time.

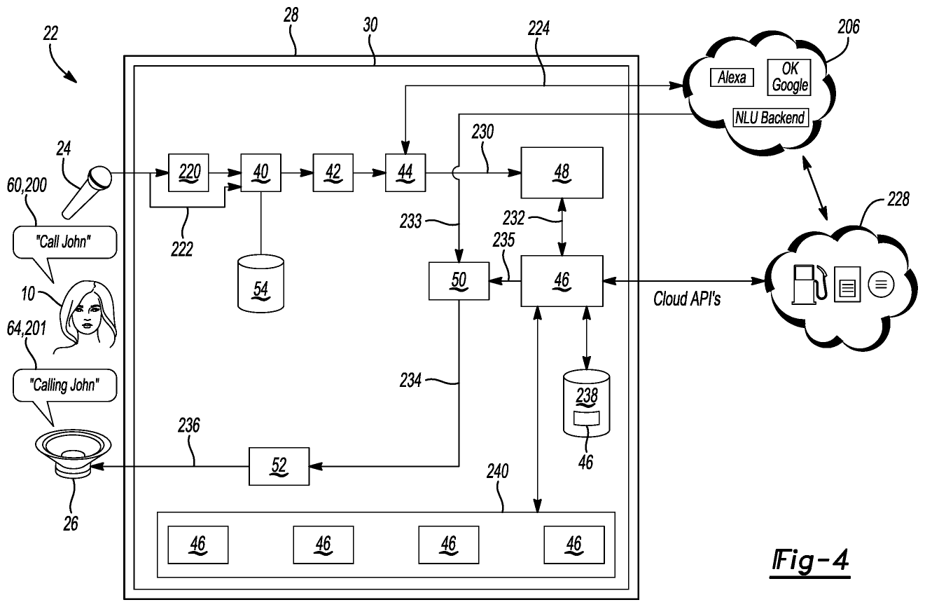

Referring to FIG. 2, the method of operating the voice assistant system of the vehicle 20 may include inputting a wake word/wake phrase. The step of inputting the wake word/wake phrase is generally indicated by box 100 shown in FIG. 2. In some embodiments, the voice assistant system may be programmed with a wake word/wake phrase. The wake word/phrase is a word/phrase spoken by the user 10 that activates the voice assistant system, as indicated by box 100. Accordingly, referring to FIG. 4, the user 10 inputs the wake word 220 into the computing device 28 to awaken or activate the voice assistant system 30. In one embodiment, the wake word/phrase may be customized or personalized for each of a plurality of different users 10. In order to do so, each of the plurality of users 10 may define or program the computing device 28 with their own respective personalized wake word/phrase. In some embodiments, programming the computing device 28 may include having the voice assistant system 30 learn the wake word/phrase for the user 10 through in vehicle training of the voice model 54 through interaction with the user 10. At least one benefit of personalizing the wake word/phrase to each respective user 10 is that a respective user 10 may activate the voice assistant system operable on the computing device 28 of the vehicle 20, without inadvertently activating a voice assistant operable on some other electronic device, such as but not limited to a smart phone, tablet, etc. Another benefit is that the user 10 may only have to remember one wake word/phrase. Yet another benefit is that each vehicle user can have their own wake word/phrase. It will be appreciated that numerous other benefits are contemplated from the various embodiments. For example, a user 10 may program a skill 46 to connect to a specific third party vendor.

The user 10 may activate the voice assistant system 30 on the computing device 28 by speaking the wake word/phrase, and then enter their requested action. The computing device 28 may then execute the requested action by first connecting to a specific third party service provider. By doing so, the user 10 may connect to the third party service provider without speaking the common wake word/phrase for that third party service provider. By not speaking the common wake word/phrase for the third party service provider, the user 10 does not also activate other electronic devices nearby to connect to that third party service provider.

In another embodiment, the computing device 28 may disable other nearby electronic devices in response to inputting the voice input into the computing device 28, to prevent the electronic device from duplicating the requested action. The step of disabling other electronic devices in the vehicle 20 is generally indicated by box 102 shown in FIG. 2. In particular, the voice assistant system may be programmed to turn off or deactivate other selected electronic devices when the user 10 inputs their respective personalized wake word/phrase, thereby preventing the other electronic devices from duplicating the requested action included in the voice input. In order to do so, the other electronic devices may need to be identified and linked to the computing device 28 of the vehicle 20, so that the computing device 28 may temporarily disable them in whole or in part, at least in regard to functionality associated with wake words/phrases.

In other embodiments, the wake word/phrase may be defined to include a commonly used wake word/phrase, e.g., “Ok Google”™. The voice assistant system may be woke by the commonly used wake word/phrase, but still makes the determination as to whether the requested action is a cloud-based action or an on-board based action with the on-board action identifier. Accordingly, if the action identifier determines that the requested action is an on-board based action, the computing device may execute the requested action with an on-board skill, even though the wake word/phrase is a commonly used wake word that would otherwise automatically trigger a cloud-based action. This approach allows the user 10 to use the same wake word/phrase for multiple devices, while the voice assistant system 30 determines the best method to execute the requested action. For example, the user 10 may say “OK Google”™, change the radio station to 103.7 FM.” While the wake phrase “OK Google”™ would normally cause a Cloud based search, the action identifier may determine that the requested action to change the radio station is an on-board based action, and execute the requested action with an on-board skill.

In embodiments where multiple voice assistant systems 30 are available, there may be one wake word/phrase for the voice assistant systems 30. Alternatively, there may be a plurality of wake words/phrases. In the case of the plurality of wake words/phrases, the user 10 may say any of the wake words/phrases to trigger the voice assistant systems 30. For example, the custom wake word may be defined as “Hey Cadillac”, the invocation of which triggers the voice assistant system 30 on the vehicle, which in turn activates other commonly used wake words/phrases such as “OK Google”™, “Alexa”™, etc., to trigger invocation of other cloud-based voice assistants.

After hearing the wake word/phrase, the computing device 28 may determine which voice assistant system 30 to use, based on a determination process. As part of the determination process, the computing device 28 may analyze the requested action to determine which voice assistant system 30 to use. As an example, the computing device 28 may include a scoring framework for the voice assistant systems 30. The scoring framework may include one or more categories, such as weather, sports, shopping, navigation/directions, miscellaneous/other, etc. For each category, the computing device 28 may have a score for each of the voice assistant systems 30. As part of the determination process, the computing device 28 may categorize the requested action into one of the categories of the scoring framework. From there, the computing device may select the voice assistant system 30 that has the highest score. The scores may be adaptable over time. The computing device 28 may utilize a machine learning process to create the categories, assign the scores, or categorize the requested action.

Once the voice assistant system has been activated, the user 10 inputs the voice input into the computing device 28 of the vehicle 20. The step of inputting the voice input is generally indicated by box 104 shown in FIG. 2. Referring to FIG. 4, in order to input the voice input into the computing device 28, the user 10 speaks into the microphone 24, which converts the sound of the user's voice into an electronic input signal 222.

Upon the user 10 inputting the voice input, the speech-to-text converter 40 then converts the voice input into a text data file. The step of converting the voice input into the text data file is generally indicated by box 106 shown in FIG. 2. In one embodiment, the speech-to-text converter 40 converts the electronic input signal into a natural language input text data file. As described above, in order to convert the voice input into the natural language input text data file, the speech-to-text converter 40 uses the voice model 54 to correlate sounds of the voice input into words, which may be saved in text form. In order to improve the accuracy of this conversion, the voice model 54 may be trained or programmed to recognize sounds in combination with typical ambient noises 62 often encountered in the vehicle 20. Additionally, the voice model 54 may be trained to recognize different characteristic of a voice, such as accent, intonation, speech pattern, etc., so that the voice model 54 may better recognize commands specific to the vehicle 20 irrespective of the differences in the user's voice and speech. Additionally, the voice model 54 may be programmed with sound models of the specific manuals of the vehicle 20, so that the voice model 54 may better recognize terminology specific to the vehicle 20. It should be appreciated that the voice model 54 may include several different individual sound models, which are generally combined to form or define the voice model 54. Each of the different individual sound models may be defined for a different language, different syntax, different accents, different ambient noises 62, etc. The more individual sound models used to define the voice model 54, the more robust and accurate the conversion of the voice input by the voice model 54 will be.

Once the speech-to-text converter 40 has converted the voice input into the natural language input text data file, the text analyzer 42 may then analyze the text data file of the voice input to determine the requested action. The step of determining the requested action is generally indicated by box 108 shown in FIG. 2. As noted above, the requested action is the specific request the user 10 makes.

In one or more embodiments, the text analyzer 42 may use real time data in conjunction with the voice input to better interpret the requested action and/or provide a suggested action based on the request. As described above, the real time data may be bundled into different groupings or contexts, e.g., a user context including real time data related to the user 10, a vehicle context including real time data related to the current operation of the vehicle 20, or a world context including real time data related to off-board considerations.

In one example, the voice input may include the statement “I need a place to eat dinner.” Since the voice input is a statement, and does not explicitly include a requested action for the voice assistant system 30 to execute, the text analyzer 42 may consider real-time data to provide a suggested action. In this example, the voice assistant system 30 may consider real time data from the user context, such as food and/or restaurant preferences, number of vehicle occupants, an itinerary of the user 10, etc. Additionally, in this example. The voice assistant system 30 may consider real time data from the vehicle context, such as available fuel/power, current location, etc. Finally, in this example, the voice assistant system 30 may consider real time data from the world context, such as the current road conditions, current traffic conditions. In this example, if the user's preferences indicate that they like Italian cuisine, the road conditions are poor, and the fuel/power levels of the vehicle 20 are low, then the voice assistant system 30 may respond to the voice input with “May I direct you to the nearest Italian restaurant?” The user 10 may then follow up with a specific requested action, such as “Yes, please direct me to my favorite Italian restaurant.” However, in this example, if the user's preference includes a specific Italian restaurant that is farther away from the current vehicle location, but the road and traffic conditions are good, and the vehicle has plenty of fuel, then the voice assistant system may respond with “May I direct you to your favorite Italian restaurant?” The user 10 may then follow up with a specific requested action, such as “No, I don't feel like Italian tonight. Please route me to the nearest Mexican restaurant instead.”

In another example, the user 10 may see a lighted symbol on the instrument cluster, and ask “What is this lighted symbol on the dash for?” The text analyzer 42 may consider real-time data to provide an answer and a suggested action. In this example, the voice assistant system 30 may consider real time data from the user context, such as but not limited to an itinerary of the user 10, and a preferred maintenance facility. Additionally, in this example, the voice assistant system 30 may consider real time data from the vehicle context, such as but not limited to which dash symbol is lighted that is not normally lighted, and diagnostics related to the lighted symbol, etc. Finally, in this example, the voice assistant system 30 may consider real time data from the world context, such as but not limited to the time of day and whether or not the preferred maintenance facility and/or a maintenance department of the nearest Dealership is currently open. In this example, if the user's preferences indicate that their desired service facility is Bob's Auto Repair and that the user 10 has an opening in their schedule Thursday morning, that the lighted symbol indicates specified vehicle maintenance, the oil life of the vehicle is at 10%, and that Bob's Auto Repair is closed Thursday but the maintenance at the nearest dealership is open Thursday morning, then the voice assistant system 30 may respond to the voice input with “The light indicates your vehicle is in need of maintenance, and your oil life is at 10%. You have an opening in your schedule Thursday morning, but Bob's Auto Repair is closed then. Would you like me to schedule an appointment with the nearest dealership for Thursday morning?” The user 10 may then follow up with a specific requested action, such as “Yes, please schedule an appointment to have my vehicle inspected at the nearest dealership on Thursday morning.”

Once the text analyzer 42 has determined or identified the requested action, the action identifier 44 determines if the requested action is a cloud-based action or an on-board based action. The step of determining if the requested action is a cloud-based action or an on-board based action is generally indicated by box 110 shown in FIG. 2. Skills 46 that are invoked based on the requested action, will possess logic to execute the requested action with on-board services, such as shown at 238 in FIG. 4, or invoke a cloud-based service via an Application Programming Interface (API) request to carry out the respective actions, such as shown at 240 in FIG. 4.

As described above, the cloud-based action indicates that the computing device 28 connect to a third party service provider via the internet, whereas the on-board based action may be completed without connecting to the internet. The steps of converting the voice input into the text data file, analyzing the text data file of the voice input to determine the requested action, and determining if the requested action is a cloud-based action or an on-board based action, may be executed by the computing device on-board the vehicle without offboard input, e.g., without connecting to the internet or any off-board service providers. By doing so, the voice assistant system 30 maintains functionality to the on-board based actions, even when the vehicle lacks an internet connection.

When the requested action is determined to be a cloud-based action, generally indicated at 112 in FIG. 2, the computing device 28 communicates or transmits the natural language input text data file to a cloud-based service provider. The step of transmitting the natural language input text data file to the cloud-based service provider is generally indicated by box 114 shown in FIG. 2. Notably, the computing device 28 communicates a text file with the cloud-based service provider, e.g., the natural language input text data file. The computing device 28 does not send a recording of the user's voice to the cloud-based service provider. As such, a recording of the user's voice is not transmitted over the internet. Rather, the computing device 28 transmits a data file, e.g., the natural language input text data file, to the cloud-based third party provider. Referring to FIG. 4, the natural language input text data file is shown at 224, being transmitted to a cloud-based service provider 226. The cloud-based service provider 226 may communicate with other cloud-based services 228 where appropriate to execute the requested action. In some embodiments, prior to transmission, the computing device 28 may encrypt the data file. Upon the computing device 28 transmitting the natural language input text data file to the cloud-based third party provider, the cloud-based third party provider may analyze the natural language input text data file, and communicate an answer or response back to the computing device 28 as shown in block 115. In various embodiments, the answer/response may be in the form of a second (or remote) machine readable data structure 233. The computing device 28 may then generate a natural language output text data file including the response answer from the cloud-based third party provider, convert the natural language output text data file to an electronic output signal, and output the voice output with the speaker 26 in response to the electronic output signal. The step of generating the natural language output text data file is generally indicated by box 116 shown in FIG. 2. The step of converting the natural language output text data file to the electronic output signal is generally indicated by box 118 shown in FIG. 2. The step of outputting the voice output with the speaker 26 is generally indicated by box 120 shown in FIG. 2.

When the requested action is determined to be an on-board based action, generally indicated at 122 in FIG. 2, the computing device 28 may convert the natural language input text data file to a first (or local) machine readable data structure 233 (see FIG. 4) with the intent parser 48. The step of converting the natural language input text data file to the first machine readable data structure is generally indicated by box 124 shown in FIG. 2. Referring to FIG. 4, the natural language input text data file is shown at 230 being communicated to the intent parser 48. The intent parser 48 transmits the first machine readable data structure 232 to one or more skills 46.

When the requested action is determined to be an on-board based action, the computing device 28 may execute the requested action with one or more of the skills 46 operable on the computing device 28 to perform the requested action. The step of executing the on-board based action is generally indicated by box 126 shown in FIG. 2. For example, if the requested action is to increase the cabin temperature of the vehicle 20, the computing device 28 may activate the HVAC system of the vehicle 20 to provide heat to increase the cabin temperature. It should be appreciated that the skills 46 may include other systems or functions that the vehicle 20 may perform.

Additionally, the skills 46 may include functions or actions that the user 10 defines specifically for a specific requested action. For example, the user 10 may define a specific skill in which the computing device 28 transmits a request or data to one of an off-board service provider or another electronic device. For example, the user 10 may define a skill 46 to include the computing device 28 communicating with the user's phone to initiate a phone call, when the requested action includes a request to call an individual. In another embodiment, the user 10 may define a skill 46 to include the computing device 28 communicating with a specific website, when the requested action includes a specific request or command. When the skill 46 includes the computing device 28 communicating with another electronic device or with a specific website, the computing device 28 may transmit the requested action to the third party provider using an appropriate format, such as but not limited to the Representational State Transfer (REST) architectural style (defined by Roy Fielding in 2000). Prior to transmission, the skill may encrypt the requested action. After reception of a response from the third party provider, the skill may decrypt the response. In various embodiments, the skill 46 may convert the response from the third party provider (e.g., off-board response) and/or a response from acting on the first machine readable data file (e.g., on-board response) into a third (or intermediate) machine readable data structure 235.

Once the computing device 28 has executed the requested action, the computing device 28 may generate a natural language output text data file 234 from the first machine readable data structure 233, the second machine readable data structure 232 and/or the third machine readable data structure 235 with the text-to-speech converter 50, providing the results from the requested action, or indicating some other message related to the requested action. The step of generating the natural language output text data file is generally indicated by box 116 shown in FIG. 2. For example, Referring to FIG. 4, if the requested action is a request to “Call John”, the computing device 28 may generate the natural language output text data file 234 including a message stating, “Calling John.” In another example, if the requested action is to purchase tickets for a movie, the computing device 28 may generate a natural language output text data file including a message stating, “Tickets for movie X have been purchased from the local movie theater.” The signal generator 52 then converts the natural language output text data file to the electronic output signal, generally indicated by box 118 shown in FIG. 2, and outputs the voice output with the speaker 26 in response to the electronic output signal, generally indicated by box 120 shown in FIG. 2. Referring to FIG. 4, the electronic output signal is generally shown at 236.

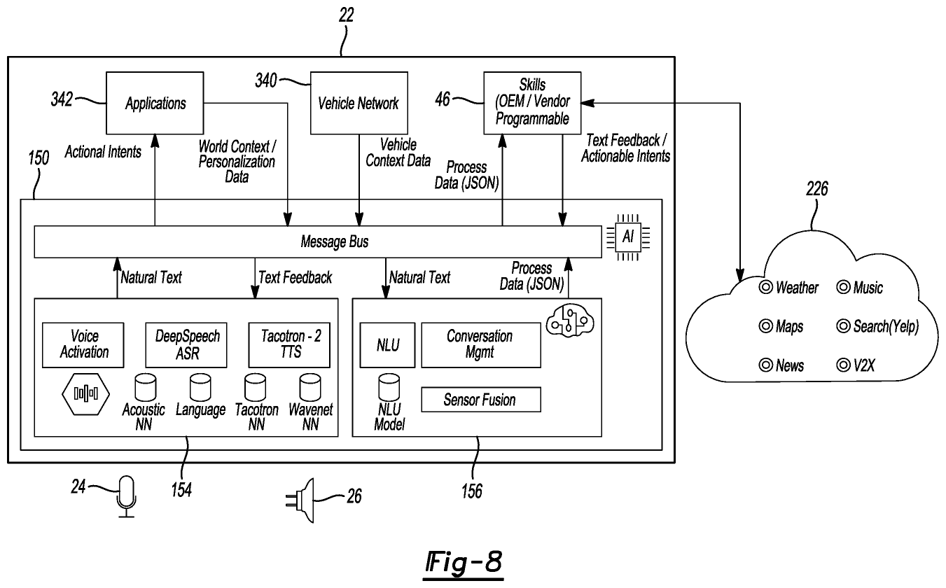

Referring to FIG. 8, a schematic block diagram of an example implementation of a smart voice assistant is shown. The smart voice assistance may include the infotainment system 22, the microphone 24, the speaker 26 and the cloud-based service provider 226. The smart voice assistant generally comprises the skills 46, the Artificial Intelligence co-processor 150, the first partition 154, the second partition 156, a vehicle network 340 and a set of application programs 342. The smart voice assistant may be implemented by the infotainment system 22.

The Artificial Intelligence co-processor 150 may provide actionable items to the application programs 342. The application programs 342 are generally operational to process the actionable items and return world context/personalization data to the Artificial Intelligence co-processor 150. The vehicle network 340 may be configured to provide vehicle context data to the Artificial Intelligence co-processor 150. Process data may be transferred from the Artificial Intelligence co-processor 150 to the skills 46. In various cases, the skills 46 may work alone or with the cloud-based service provider 226 to generate text feedback and/or actionable intents that are returned to the Artificial Intelligence co-processor 150.

In various embodiments, the microphone 24 may be constantly listening and the voice activation block may be responsible for inferring the wake up-words and/or wake-up phrases. The DeepSpeech automatic speech recognition (ASR) block may be activated when a valid wake up-word/phrase is detected. The DeepSpeech automatic speech recognition block may subsequently start decoding the spoken voice input using the acoustic neural network and the language model. The resulting decoded text is generally sent to the natural language understanding (NLU) block in the second partition 156 via the message bus. The natural language understanding block may perform the natural language understanding functions.

The natural language understanding block generally identifies the meaning of the spoken text and extracts the intent and entities that define the actions that the user 10 is intending to take. Identified intent may be passed to the conversation management block. The conversation management block generally detects if the identified intent has any ambiguity or if the intent is complete. If the intent is complete, the conversion management block may look to the context management block (e.g., via the sensor fusion block) to see if the intended action may be completed. If the intended action may be completed, control proceeds to invoke one or more skills or applications to act on the identified intent, which may be shared as JSON structures. If the intent action may not be completed or is ambiguous, the text-to-speech (TTS) block, in the first partition 154, may be invoked to ask the user 10 to resolve the ambiguity, followed by invocation of the automatic speech recognition to obtain more spoken input from the user 10.

The application programs 342 and the vehicle network 340 may share periodic updates of changes happening with respect to the world context/personal data and the vehicle context data (e.g., vehicle sensor data), respectively. The world context/personal data and the vehicle context data may be used by the sensor fusion block to determine the current context to validate the incoming intent at any given time.

Referring to FIG. 9, a schematic block diagram of an example implementation of a training/inference process is shown. The training/inference process (or method) may be implemented in the infotainment system 22 to train the speech-to-text converter 40 and the voice model 54. The training/inference process generally comprises a speech block 350, a feature extraction block 352, a neural network model decoder 354, a models block 356, a results block 358, a word error rate calculator block 360, a loss functions block 362, and a data block 364. Live audio may be received by the speech block 350 from the microphone 24.

The training/inference process may be use one or more machine learning techniques to improve models in speech-to-text conversions. An example implementation of a speech-to-text conversion may be a DeepSpeech conversion system, developed by Baidu Research. Training data stored in the data block 364 may provide audio into the speech-to-text conversion. After decoding, the recognized text extracted from the audio may be compared to reference text of the audio to determine word error rates. The word error rates may be used to update the models to adjust weights and biases of a neural network (e.g., a recurrent neural network (RNN)) used in the conversion.

In some designs, the speech model training process generally involves feeding of recorded audio training data in the data block 364 to the feature extractor 352. The feature extractor 252 may obtain cepstral coefficients of the incoming audio stream from the speech block 350. The cepstral coefficients may be presented to the neural network model decoder 354 for decoding the incoming audio and predicting the most likely text. The most likely text may subsequently be compared with the original transcribed text (from the data block 364) by the results block 358 to obtain an estimated text. An estimated word error rate may be determined by the word error rate calculator block 360 to calculate a model accuracy. The loss function block 362 may be used to update the recurrent neural network weights and biases based on the results of the loss function block 362 to create an updated model.

A speech inference process flow generally involves capturing of live microphone audio input from the microphone 24, followed by the feature extraction block 352 and the decoding of text using the static recurrent neural network model and the language model 354, which produces the expected results in the form of a most likely text.

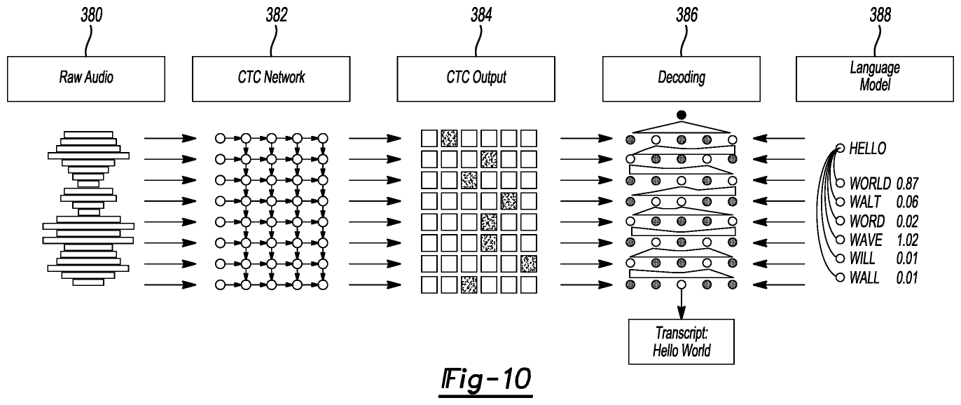

Referring to FIG. 10, a schematic diagram of an example speech inference data flow is shown. The speech inference data flow may be implemented in the infotainment system 22. The data flow generally comprises raw audio 380, a connectionist temporal classification (CTC) network 382, CTC output data 384, a language model decoder block 386 and words 388.

The connectionist temporal classification network 382 generally provides the CTC output data 384 and a scoring function for training the neural network (e.g., the recurrent neural network). The raw audio 380 generally includes a sequence of observations. The CTC output data 384 may be a sequence of labels. The CTC output data 384 is subsequently decoded by the language model decoder block 386 to produce a transcript (e.g., the words 388) of the raw audio 380. For training, the CTC scores may be used with a back-propagation process to update neural network weights.

In some embodiments, the raw audio 380, recorded from the microphone 24, may be fed to the neural network (e.g., the connectionist temporal classification network 382) to determine the sequence of characters as the CTC output data 384 decoded by the neural network. The sequence of characters may be fed to the language model decoder 386 for decoding of the words 388 that form a proper meaning/vocabulary, which provides the most likely text that user 10 has spoken.

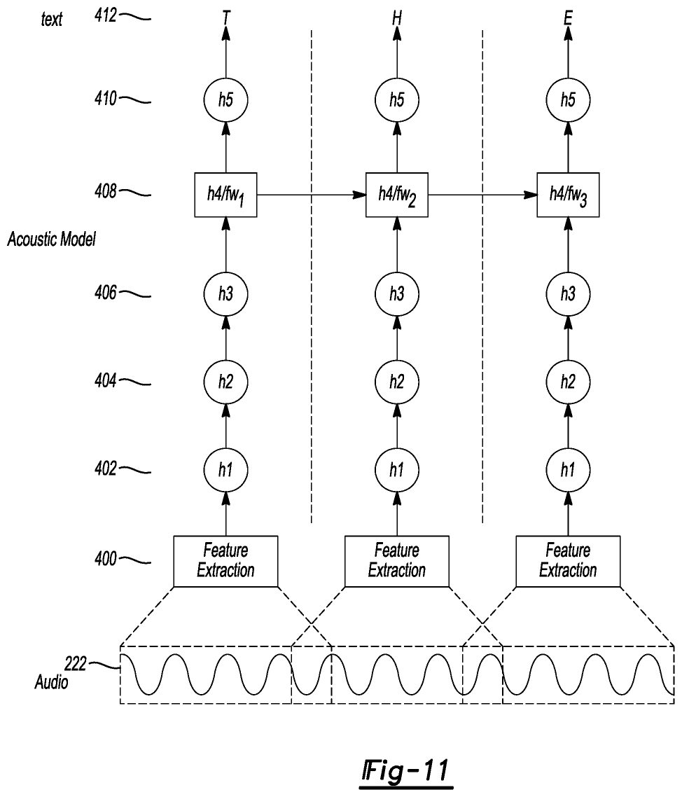

Referring to FIG. 11, a schematic diagram of an example implementation of a speech neural network acoustic model is shown. The speech neural network acoustic model may be implemented in the infotainment system 22. The speech neural network acoustic model generally comprises a feature extraction layer 400, a layer 402, a layer 404, a layer 406, a layer 408 and a layer 410. The layer 400 may receive the electronic input signal 222 as a source of audio input. The layer 410 may generate text 412.

The speech neural network acoustic model generally illustrates audio data in the electronic input signal 222 to the feature extraction layer 400, through three fully connected layers 402 (e.g., h1), 404 (e.g., h2) and 406 (e.g., h3). In the fourth layer 408 (e.g., h4), a unidirectional recurrent neural network layer may be implemented to process blocks of the audio data (e.g., 100 millisecond blocks) as the audio data becomes available. A final state of each column in the fourth layer 408 may be used as an initial state in a neighboring column (e.g., fw1 feeds into fw2, fw2 feeds into fw3, etc.). Results produced by the fourth layer 408 may subsequently be processed by the fifth layer 410 (e.g., h5) to create the individual characters of the text 412.

In various embodiments, the raw audio 222 obtained through the microphone 24 may be fed to the feature extraction process 400 to convert the incoming audio into the cepstral form (e.g., a nonlinear “spectrum-of-a-spectrum”) which is understood by the first layer (e.g., h1) 402 of the neural network. Incoming data from feature extractor may be fed through a multiple (e.g., 5) layer network (e.g., h1 to h5) comprising many (e.g., 2048) neurons/layers that have pre-trained weights and biases based on audio data from earlier training. The network layers h1 to h5 may be operational to predict the characters that were spoken. Layer four (e.g., h4) 408 may be a fully connected layer, where all neurons may be connected, and an input from one neuron is fed into the next neuron.

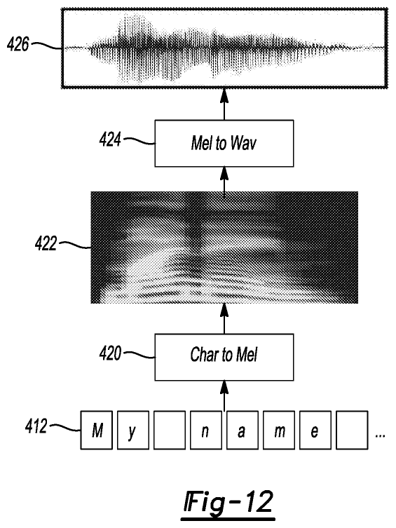

Referring to FIG. 12, a schematic block diagram of an example implementation of a neural text-to-speech system is shown. The neural text-to-speech system may implement the text-to-speech converter 50. The neural text-to-speech system generally comprises a character to mel converter network 420, a mel spectrogram 422 and a mel to way converter network 424. The character to mel converter network 420 may receive the text 412 as a source of input text. The mel to way converter network 424 may generate and present a way audio file 426. The term “mel” generally refers to a melody scale. A mel scale is a scale of pitches judged by humans to be equal in distance from one another. A mel spectrogram is a spectrogram with a mel scale as an axis. The mel spectrogram may be an acoustic time-frequency representation of a sound. The way audio file 426 may be a standard audio file format for representing audio.

In various designs, the mel converter network 420 may be implemented as a recurrent sequence-to-sequence feature prediction network with attention. The recurrent sequence-to-sequence feature prediction network may predict a sequence of mel spectrogram frames from the input character sequence in the text 412. The mel to way converter network 424 may be implemented as a modified version of a WaveRNN network. The modified WaveRNN network may generate the time-domain waveform samples 426 conditioned on the predicted mel spectrogram 422.

In some embodiments, the text-to-speech system may be implemented with a Tacotron 2 system created by Google, Inc. The Tacotron 2 system generally comprises two separate networks. An initial network may implement a feature prediction network (e.g., character to mel prediction in 420). The prediction network may produce the mel spectrogram 422. The second network may implement a vocoder (or voice encoder) network (e.g., mel to way voice encoding in 424). The vocoder network may generate waveform samples in the way audio file 426 corresponding to the mel spectrogram features.

In various implementations, the text-to-speech system (or speech synthesis) generally involves conversion of text to spoken audio, which is a two stage process. The given text may first be converted into the mel spectrogram 422 as an intermediate form and subsequently transformed into the way audio form 426, that may be used for audio playback. The mel-spectrogram 422 generally represents the audio in frequency domain using the mel scale.

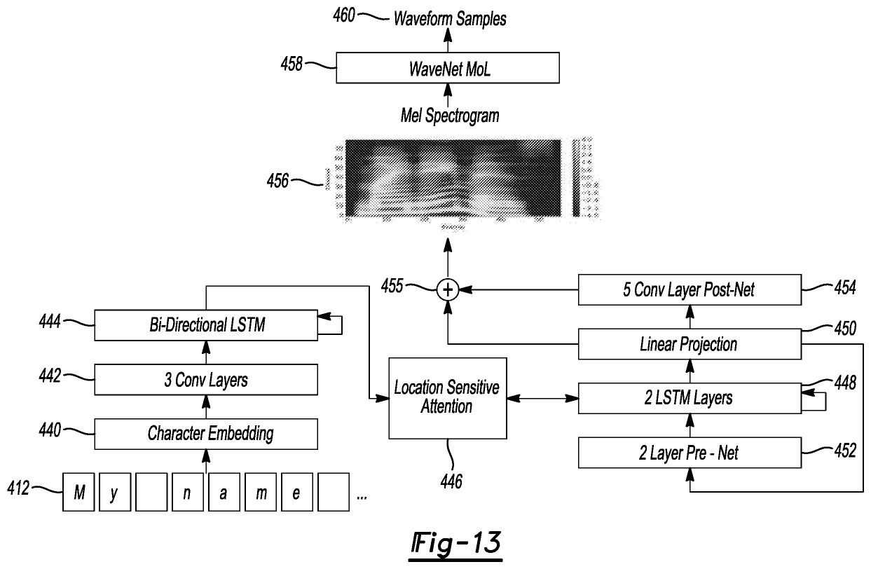

Referring to FIG. 13, a schematic block diagram of an example implementation of a Tacotron 2 neural network is shown. The neural network may be implemented by the infotainment system 22. The neural network generally comprises a character embedding block 440, three conversion layers 442, a bi-directional long short-term memory (LSTM) block 444, a location sensitive attention network 446, two LSTM layers 448, a linear projection block 450, two layer pre-network block 452, a five-layer convolutional post-network block 454, a summation block 455, a mel spectrogram frame 456 and a WaveNet MoL block 458. The character embedding block 440 may receive the text 412 as a source of input text. The WaveNet MoL block 458 may generate waveform samples 460. Long short-term memory generally refers to an artificial recurrent neural network used for learning applications. WaveNet generally refers to a neural network for generating the raw audio waveform samples 460. MoL generally refers to a discretized mixture of logistics distribution used in WaveNet.

The character embedding block 410 may covert the text 412 to feature representations. The convolution layers 442 to filter and normalize the feature representations. The feature representations may subsequently be converted to encoded features by the bi-directional LSTM block 444. The location sensitive attention network 446 may summarize the encoded feature sequences to generate fixed-length context vectors. The two LSTM layers 448 may begin decoding of the fixed-length context vectors. Concatenated data generated by the LSTM layers 448 and attention context vectors are passed through the linear projection block 450 to predict target spectrogram frames.

The predicted target spectrogram frames may be processed by the two layer pre-net block 452 to update the context vectors in the LSTM layers 448. The updated predicted target spectrogram frames are processed by the 5-layer convolution post-net block 454 to generate residuals. The residuals are added to the predicted target spectrogram frames by the summation block 455 to create the mel spectrogram frames 456. The WaveNet MoL block 458 generally produces the waveform samples 460 from the mel spectrogram frames 456.

In various embodiments, the text-to-speech conversion system may be implemented as a two stage process (e.g., blocks 412-455 and blocks 456-460). The first stage 412-455 may implement a recurrent sequence-to-sequence feature prediction network with attention that predicts a sequence of mel spectrogram frames 456 from the input character sequence in the text 412. The second stage 456-460 may be a modified version of WaveNet that generates the time-domain waveform samples conditioned on the predicted mel-spectrogram frames 456.

Referring to FIG. 14, a schematic block diagram of an example implementation of a training/inference process for the Tacotron 2 system is shown. The training/inference process (or method) may be implemented by the infotainment system 22. The training/inference process generally comprises an encoder block 480, a codec block 482, a data block 484 and an encoder model block 486. The encoder block 480 may receive the text 412 and/or prerecorded text from the data block 484 as a source of input text. An encoder model and a WaveNet model may be updated by the training process. An output result of the training process is to generate two neural network models, one for the encoding part and another for the WaveNet decoder, which may handle the two stage synthesis process to convert the text to more natural sounding audio.

The speech synthesis training process generally involves feeding of the text data to encoder processing block 480, which updates the weights/biases in the encoder model 486 and produces the most likely mel-spectrogram output. The most likely mel-spectrogram output may then be fed through the loss function, which compares to pre-generated mel-spectrograms to the newly generated spectrograms, to calculate the loss value. The loss value generally determines how much further training of the model may be appropriate for the same input dataset to make the model learn better.

The second stage of the training process generally involves feeding the pre-generated mel spectrograms to the WaveNet vocoder. The WaveNet vocoder may update the weights/biases in the decoder model and produce the most likely audio output. The most likely audio output is subsequently fed through the loss function, which compares to pre-recorded audio files to the newly generated audio to calculate the loss value.

The synthesis process generally involves conversion of input text into mel spectrograms using the encoder block 480, followed by the decoder block 482 to decode the mel-spectrogram using the WaveNet vocoder to create the audio that may be played back to the user 10.

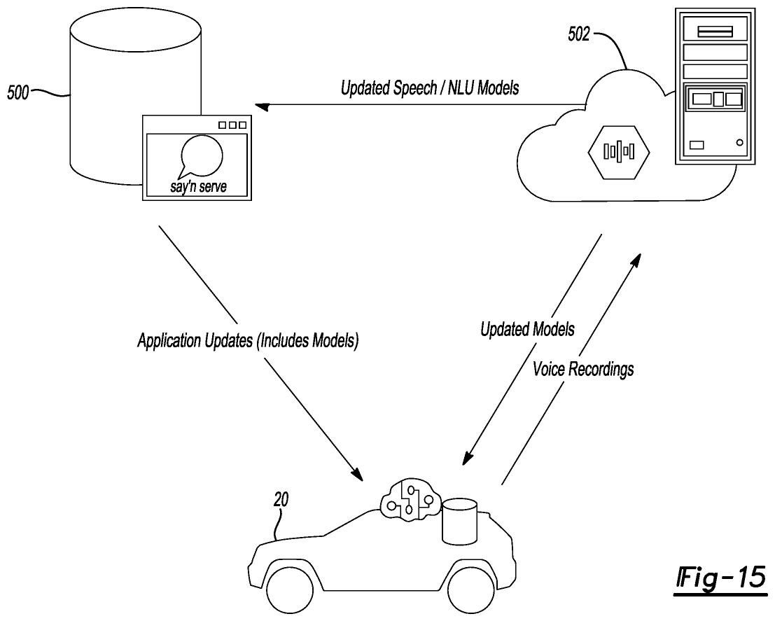

Referring to FIG. 15, a schematic block diagram of an example implementation of a technique for continuous improvements and updates is shown. The technique generally comprises the vehicle 20, an application store 500 and a virtual machine 502. The application store 500 may be hosted by a server computer of an original equipment manufacturer (OEM) of the infotainment system 22. In various embodiments, the virtual machine 502 may be hosted by one or more cloud servers.

The infotainment system 22 may have a memory (e.g., a cache) to store the voice recordings. The vehicle may upload the voice samples from the memory to the virtual machine 502 when connected. The virtual machine 502 generally hosts a sophisticated model to obtain accurate transcriptions for the incoming voice samples.

The virtual machine 502 may continuously train Artificial Intelligence models (used by the vehicle 20) based on the voice samples. The updated (trained) Artificial Intelligence models may be pushed directly to vehicle 20. The virtual machine 502 may also continuously update speech/natural language understanding models based on the voice samples. The updated speech/natural language understanding models may be transferred to the application store 500. From the application store 500, the updated speech/natural language understanding models, and a various situations new models may be transferred to the vehicle 20 to improve the infotainment system 22.

In various embodiments, the voice recordings from the on-board system of the vehicle 20 may be cached (e.g., when offline) and sent to the virtual machine 502 in the cloud back-end. The models may be updated/trained by the virtual machine 502 based on the new voice samples. The updated models are generally made available to the application store 500 (e.g., in the OEM cloud) from where the voice assistant system 30 as a whole or just the speech models may be pushed back to the vehicle 20.

The process described above provides an efficient voice assistant system for the vehicle 20. The process enables some of the requested actions to be completely executed by the systems of the vehicle 20. Accordingly, in those circumstances where the vehicle 20 is capable of completely executing the requested action, a connection to the internet is not appropriate. Additionally, the computing device 28 does not send voice recordings of the user 10 over the internet. Rather, when the requested action is determined to be a cloud-based action, the computing device 28 sends the natural language input text data file, thereby providing increases security for the user 10. Because many vehicles are now equipped with a GPU 36 and/or an NPU 38, the CPU 34 may assign certain portions of the process to the GPU 36 and/or the NPU 38 to increase the response time of the system. In other embodiments, the vehicle 20 or the voice assistant system 30 may be equipped with the AI co-processor to efficiently execute the process described herein.

The computing device 28 may be updated via an over-the-air process. As an example, a new skill may be downloaded from the Cloud and stored on-board the vehicle 20, in the computing device 28. As another example, an existing skill stored on-board the vehicle, in the computing device 28, may be updated via the Cloud. To do so, a user 10 may provide a voice input to download a new skill or update an existing skill, which the computing device 28 may determine is a requested action for the Cloud. The computing device 28 may pass along the requested action to the Cloud, and the Cloud may send back to the vehicle 20 the new skill or update for the existing skill.

The computing device 28 may utilize a machine learning process. As an example, the computing device 28 may utilize one or more deep learning algorithms from receipt of a voice input, to converting the voice input into a text data file, to training the voice model 54, to determining a requested action of the input text data file, to determining if the requested action is a cloud-based action or an on-board based action, to converting the input text data file into a machine readable data structure, to converting the machine readable data structure to an output text data file, or to converting the output text data file into an electronic output signal, to training a skill 46. Through utilizing the machine learning process, such as one that spans from voice input to voice output, the infotainment system 22 yields more accurate and robust speech recognition. As an example, the machine learning process may yield a language and accent agnostic framework. This may increase the scope of possible users 10. This may further increase user experience, for a user 10 may be able to speak naturally. Instead of the user 10 having to learn how to alter his/her speech, such as patterns or utterances, in order to get a speech recognition system to produce a desired result, the machine learning process may allow the user 10 to speak naturally. The onus of learning is placed on the computing device 28, as opposed to the user 10. Additionally, the machine learning process may improve word-error-rate. This may improve the performance and robustness of speech recognition on the computing device 28.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. A system (21) for a vehicle (20), the system comprising:
a microphone (24) operable to generate an electronic input signal (222) in response to an acoustic input signal (60);
a speaker (26) operable to generate an acoustic output signal (64) in response to an electronic output signal (236);
a transceiver (27) operable to communicate with a cloud-based service provider (226); and
a computing device (28) in communication with the microphone, the speaker and the transceiver, wherein the computing device includes:
a voice model (54) operable to recognize a voice input (200) within the electronic input signal;
a speech-to-text converter (40) operable to convert the voice input into a natural language input text data file (224);
a text analyzer (42) operable to determine a requested action (108) within the natural language input text data file;
an action identifier (44) operable to determine (110) if the requested action is a cloud-based action (112) or an on-board based action (122);
an intent parser (48) operable to convert the natural language input text data file into a first machine readable data structure (232) in response to the requested action being determined to be the on-board based action;
at least one skill (46) enabled by the first machine readable data structure to perform (126) the requested action;
a communication module (56) operable to:
transmit (114) the natural language input text data file through the transceiver to the cloud-based service provider in response to the requested action being determined to be the cloud-based action; and
receive (115) a second machine readable data structure (233) through the transceiver from the cloud-based service provider in response to the natural language input text data file;
a text-to-speech converter (50) operable to convert the second machine readable data structure to a natural language output text data file (234); and
a signal generator (52) operable to convert the natural language output text data file to the electronic output signal.

2. The system set forth in claim 1, wherein:
the computing device includes a central processing unit (34) configured to convert (124) the voice input into the natural language input text data file with the speech-to-text converter, and analyze the natural language input text data file of the voice input with the text analyzer (42) to determine the requested action.

3. The system set forth in claim 1, wherein:
the computing device is operable to recognize a plurality of wake words (220); and
each of the plurality of wake words is a personalized word for an individual one of a plurality of users (10).

4. The system set forth in claim 3, wherein the computing device is operable to disable an electronic device (23) in the vehicle in response to recognizing at least one of the wake words to prevent the electronic device from duplicating the requested action.

5. The system set forth in claim 1, wherein the computing device is operable to remove an ambient noise (62) from the voice input with the voice model, wherein the ambient noise includes a noise present in the vehicle during operation of the vehicle.

6. The system set forth in claim 1, wherein the computing device is operable to communicate with an electronic device (23) in the vehicle.

7. The system set forth in claim 1, wherein the computing device is operable to train (304) the voice model through interaction with a user (10).

8. The system set forth in claim 1, wherein the computing device includes an Artificial Intelligence co-processor (150), and a processor (34,36,38) in communication with the Artificial Intelligence co-processor.

9. A computer-readable medium (32) on which is recorded instructions, executable by at least one processor (34,35,36) in communication with a microphone (24), a speaker (26) and a transceiver (27), and disposed on-board a vehicle (20), wherein execution of the instructions causes the at least one processor to:
receive (104) an electronic input signal (222) from the microphone;
recognize (42) a voice input (200) within the electronic input signal with a voice model (54) operable on the at least one processor;
convert (106) the voice input into a natural language input text data file (224) with a speech-to-text converter (40) operable on the at least one processor;
analyze (108) the natural language input text data file of the voice input to determine a requested action (108) with a text analyzer (42) operable on the at least one processor;
determine (110) if the requested action is a cloud-based action (112) or an on-board based action (122) with an action identifier (44) operable on the at least one processor;
convert (124) the natural language input text data file into a first machine readable data structure (232) with an intent parser (48) operable on the at least one processor in response to the requested action being determined to be the on-board based action;
perform (126) the requested action with a skill (46) enabled by the first machine readable data structure and operable on the at least one processor in response to the requested action being determined to be the on-board based action;
cause the natural language input text data file to be transmitted (114) through the transceiver to a cloud-based service provider (226) in response to the requested action being determined to be the cloud-based action;
receive (115) a second machine readable data structure (233) through the transceiver from the cloud-based service provider in response to the natural language input text data file;
convert (50) the second machine readable data structure to a natural language output text data file (234) with a text-to-speech converter (50) operable on the at least one processor; and
convert (52) the natural language output text data file to the electronic output signal (236) with a signal generator (52) operable on the at least one processor, wherein an acoustic output signal (64) is generated by the speaker in response to the electronic output signal.

10. The computer readable medium set forth in claim 9, wherein execution of the instructions further causes the at least one processor to:
activate (100) a voice assistant system in response to recognizing a wake word (220) in the electronic input signal.

11. The computer readable medium set forth in claim 10, wherein a personalized wake phrase (220) is defined for a user (10).

12. The computer readable medium set forth in claim 11, wherein the personalized wake word for the user includes a respective personalized wake word defined for each of a plurality of users.

13. The computer readable medium set forth in claim 10, wherein execution of the instructions further causes the at least one processor to:
disable (102) an electronic device (23) in the vehicle in response to recognizing the wake word to prevent the electronic device from duplicating the requested action.

14. The computer readable medium set forth in claim 9, wherein converting the voice input into the natural language input text data file includes training (304) a voice model (54) to recognize the voice input.

15. The computer readable medium set forth in claim 14, wherein training the voice model includes training the removal of an ambient noise (62) from the voice input, wherein the ambient noise includes a noise in the vehicle during operation of the vehicle.

16. The computer readable medium set forth in claim 15, wherein training the voice model includes training a plurality of different sound models (356), with each sound model having a different respective ambient noise.

17. The computer readable medium set forth in claim 9, wherein performing the requested action with the skill operable on the at least one processor includes communicating with one of a cloud-based service provider (226) or an electronic device (23) in the vehicle.

18. The computer readable medium set forth in claim 9, wherein execution of the instructions further causes the at least one processor to:
convert (50) a third machine readable data structure into the natural language output text data file (234) with the text-to-speech converter (50) operable on the at least one processor.

19. A method of operating a voice assistant system (30) of a vehicle (20), the method comprising:
receiving (104) an electronic input signal (222) into a computing device (28) disposed on-board the vehicle;
recognizing (42) a voice input (200) within the electronic input signal with a voice model (54) operable on the computing device;
converting (106) the voice input into a natural language input text data file (224) with a speech-to-text converter (40) operable on the computing device;
analyzing (108) the natural language input text data file of the voice input to determine a requested action (108) with a text analyzer (42) operable on the computing device;
determining (110) if the requested action is a cloud-based action (112) or an on-board based action (122) with an action identifier (44) operable on the computing device;
converting (124) the natural language input text data file into a first machine readable data structure (232) with an intent parser (48) operable on the computing device in response to the requested action being determined to be the on-board based action;
performing (126) the requested action with a skill (46) enabled by the first machine readable data structure and operable on the computing device in response to the requested action being determined to be the on-board based action;
transmitting (114) the natural language input text data file to a cloud-based service provider (226) in response to the requested action being determined to be the cloud-based action;
receiving (115) a second machine readable data structure (233) from the cloud-based service provider in response to the natural language input text data file;
converting (50) the second machine readable data structure to a natural language output text data file (234) with a text-to-speech converter (50) operable on the computing device;
converting (52) the natural language output text data file to the electronic output signal (236) with a signal generator (52) operable on the computing device; and
generating (26) an acoustic output signal (64) in response to the electronic output signal.

20. The method set forth in claim 19, wherein the computing device includes a central processing unit (34), and wherein voice recognition processing, natural language processing, text-to-speech processing, converting the voice input into the natural language input text data file, and analyzing the natural language input text data file of the voice input to determine the requested action are performed solely by the central processing unit.
